(19) United States
(12) Patent Application Publication
(10) Pub. No.: US 2020/0266426 A1
(43) Pub. Date: Aug. 20, 2020

(54) CHEMICAL-FREE PRODUCTION METHOD OF GRAPHENE-ENCAPSULATED ELECTRODE ACTIVE MATERIAL PARTICLES FOR BATTERY APPLICATIONS

(71) Applicant: Nanotek Instruments, Inc., Dayton, OH (US)

(72) Inventors: Aruna Zhamu, Springboro, OH (US); Hao-Hsun Chang, Centerville, OH (US); Bor Z. Jang, Centerville, OH (US)

(73) Assignee: Nanotek Instruments, Inc., Dayton, OH (US)

(21) Appl. No.: 16/277,395

(22) Filed: Feb. 15, 2019

(51) Int. Cl. H01M 4/36; H01M 4/587; H01M 4/505; H01M 4/525; H01M 4/50; H01M 4/58; H01M 4/60; H01M 4/48; H01M 4/38

(52) U.S. Cl. CPC H01M 4/364; H01M 4/366; H01M 4/587; H01M 4/505; H01M 4/525; H01M 4/502; H01M 2004/028; H01M 4/5825; H01M 4/60; H01M 4/483; H01M 4/38; H01M 4/386; H01M 4/581; H01M 4/5815

(57) ABSTRACT

Provided is a simple, fast, scalable, and environmentally benign method of producing graphene-embraced particles of a battery electrode active material, comprising: a) mixing graphitic material particles and multiple particles of a milling media to form a mixture in an impacting chamber of an energy impacting apparatus; b) operating the energy impacting apparatus with a frequency and an intensity for a length of time sufficient for transferring graphene sheets from the graphitic material to surfaces of milling media particles to produce graphene-embraced milling media particles; c) mixing particles of an active material with graphene-embraced milling media particles in an impacting chamber of an energy impacting apparatus; d) operating the energy impacting apparatus for transferring graphene sheets from the graphene-embraced milling media particles to surfaces of active material particles to produce graphene-embraced electrode active material particles; and e) recovering these graphene-embraced active material particles from the impacting chamber.

### FIELD OF THE INVENTION

The present invention relates generally to the field of lithium batteries and, in particular, to an environmentally benign and cost-effective method of producing graphene-protected electrode active materials for lithium batteries.

### BACKGROUND

The most commonly used anode materials for lithium-ion batteries are natural graphite and synthetic graphite (or artificial graphite) that can be intercalated with lithium and the resulting graphite intercalation compound (GIC) may be expressed as LiₓC₆, where x is typically less than 1. The maximum amount of lithium that can be reversibly intercalated into the interstices between graphene planes of a perfect graphite crystal corresponds to x=1, defining a theoretical specific capacity of 372 mAh/g.

In addition to carbon- or graphite-based anode materials, other inorganic materials that have been evaluated for potential anode applications include metal oxides, metal nitrides, metal sulfides, and the like, and a range of metals, metal alloys, and intermetallic compounds that can accommodate lithium atoms/ions or react with lithium. Among these materials, lithium alloys having a composition formula of LiₐA (A is a metal such as Al, and “a” satisfies 0<a<5) are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, in the anodes composed of these materials, severe pulverization (fragmentation of the alloy particles) occurs during the charge and discharge cycles due to expansion and contraction of the anode active material induced by the insertion and extraction of the lithium ions in and out of the anode active material. The expansion and contraction, and the resulting pulverization of active material particles lead to loss of contacts between active particles and conductive additives and loss of contacts between the anode active material and its current collector. These adverse effects result in a significantly shortened charge-discharge cycle life.

To overcome the problems associated with such mechanical degradation, three technical approaches have been proposed:
(1) reducing the size of the active material particle, presumably for the purpose of reducing the strain energy that can be stored in a particle, which is a driving force for crack formation in the particle. However, a reduced particle size implies a higher surface area available for potentially reacting with the liquid electrolyte. Such a reaction is undesirable since it is a source of irreversible capacity loss.
(2) depositing the electrode active material in a thin film form directly onto a current collector, such as a copper foil. However, such a thin film structure with an extremely small thickness-direction dimension (typically much smaller than 500 nm, often necessarily thinner than 100 nm) implies that only a small amount of active material can be incorporated in an electrode (given the same electrode or current collector surface area), providing a low total lithium storage capacity and low lithium storage capacity per unit electrode surface area (even though the capacity per unit mass can be large). Such a thin film must have a thickness less than 100 nm to be more resistant to cycling-induced cracking, further diminishing the total lithium storage capacity and the lithium storage capacity per unit electrode surface area. Such a thin-film battery has very limited scope of application. A desirable and typical electrode thickness is from 100 μm to 200 μm. These thin-film electrodes (with a thickness of <500 nm or even <100 nm) fall short of the required thickness by three (3) orders of magnitude, not just by a factor of 3.
(3) using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nanoparticles. Presumably, the protective matrix provides a cushioning effect for particle expansion or shrinkage, and prevents the electrolyte from contacting and reacting with the electrode active material. Examples of anode active particles are Si, Sn, and SnO₂. Unfortunately, when an active material particle, such as Si particle, expands during the battery charge step, the protective coating is easily broken due to the mechanical weakness and/or brittleness of the protective coating materials. There has been no high-strength and high-toughness material available that is itself also lithium ion conductive.
   It may be further noted that the coating or matrix materials used to protect active particles (such as Si and Sn) are carbon, sol gel graphite, metal oxide, monomer, ceramic, and lithium oxide. These protective materials alone are all very brittle, weak (of low strength), and/or non-conducting (e.g., ceramic or oxide coating). Ideally, the protective material should meet the following requirements: (a) The coating or matrix material should be of high strength and stiffness so that it can help to refrain the electrode active material particles, when lithiated, from expanding to an excessive extent. (b) The protective material should also have high fracture toughness or high resistance to crack formation to avoid disintegration during repeated cycling. (c) The protective material must be inert (inactive) with respect to the electrolyte, but be a good lithium ion conductor. (d) The protective material must not provide any significant amount of defect sites that irreversibly trap lithium ions. (e) The protective material must be lithium ion conductive. The prior art protective materials all fall short of these requirements. Hence, it was not surprising to observe that the resulting anode typically shows a reversible specific capacity much lower than expected. In many cases, the first-cycle efficiency is extremely low (mostly lower than 80% and some even lower than 60%). Furthermore, in most cases, the electrode was not capable of operating for a large number of cycles. Additionally, most of these electrodes are not high-rate capable, exhibiting unacceptably low capacity at a high discharge rate.

Due to these and other reasons, most of prior art composite electrodes have deficiencies in some ways, e.g., in most cases, less than satisfactory reversible capacity, poor cycling stability, high irreversible capacity, ineffectiveness in reducing the internal stress or strain during the lithium ion insertion and extraction steps, and other undesirable side effects.

Thus, there is an urgent and continuing need for a new anode for the lithium-ion battery that has a high cycle life, high reversible capacity, low irreversible capacity, small particle sizes (for high-rate capacity), and compatibility with commonly used electrolytes. There is also a need for a method of readily or easily producing such a material in large quantities.

Due to extremely poor electrical conductivity of all cathode (positive electrode) active materials in a lithium-ion, lithium metal, or lithium-sulfur cell, a conductive additive (e.g. carbon black, fine graphite particles, expanded graphite particles, or their combinations), typically in the amount of 5%-20%, must be added into the electrode. In the case of a lithium-sulfur cell, a carbon amount as high as 50% by weight is used as a conductive support for sulfur in the cathode. However, the conductive additive is not an electrode active material (i.e. it is not capable of reversibly storing lithium ions). The use of a non-active material means that the relative proportion of an electrode active material, such as LiFePO₄, is reduced or diluted. For instance, the incorporation of 5% by weight of PVDF as a binder and 5% of carbon black as a conductive additive in a cathode would mean that the maximum amount of the cathode active material (e.g., lithium cobalt oxide) is only 90%, effectively reducing the total lithium ion storage capacity. Since the specific capacities of the more commonly used cathode active materials are already very low (140-170 mAh/g), this problem is further aggravated if a significant amount of non-active materials is used to dilute the concentration of the active material.

State-of-the-art carbon black (CB) materials, as a conductive additive, have several drawbacks:
(1) CBs are typically available in the form of aggregates of multiple primary particles that are typically spherical in shape. Due to this geometric feature (largest dimension-to-smallest dimension ratio or aspect ratio ˜1) and the notion that CBs are a minority phase dispersed as discrete particles in an electrically insulating matrix (e.g. lithium cobalt oxide and lithium iron phosphate), a large amount of CBs is required to reach a percolation threshold where the CB particles are combined to form a 3-D network of electron-conducting paths.
(2) CBs themselves have a relatively low electrical conductivity and, hence, the resulting electrode remains to be of relatively low conductivity even when the percolation threshold is reached. A relatively high proportion of CBs (far beyond the percolation threshold) must be incorporated in the cathode to make the resulting composite electrode reasonably conducting.

Clearly, an urgent need exists for a more effective electrically conductive additive material. Preferably, this electrically conductive additive is also of high thermal conductivity. Such a thermally conductive additive would be capable of dissipating the heat generated from the electrochemical operation of the Li-ion battery, thereby increasing the reliability of the battery and decreasing the likelihood that the battery will suffer from thermal runaway and rupture. With a high electrical conductivity, there would be no need to add a high proportion of conductive additives.

There have been several attempts to use other carbon nanomaterials than carbon black (CB) or acetylene black (AB) as a conductive additive for the cathode of a lithium battery. These include carbon nanotubes (CNTs), vapor-grown carbon nanofibers (VG-CNFs), and simple carbon coating on the surface of cathode active material particles. The result has not been satisfactory and hence, as of today, carbon black and artificial graphite particles are practically the only two types of cathode conductive additives widely used in lithium ion battery industry. The reasons are beyond just the obvious high costs of both CNTs and VG-CNFs. The difficulty in disentangling CNTs and VG-CNFs and uniformly dispersing them in a liquid or solid medium has been an impediment to the more widespread utilization of these expensive materials as a conductive additive. Additionally, the production of both CNTs and VG-CNFs normally require the use of a significant amount of transition metal nanoparticles as a catalyst. It is difficult to remove and impossible to totally remove these transition metal particles, which can have adverse effect on the cycling stability of a lithium metal.

As for the less expensive carbon coating, being considered for use in lithium iron phosphate, the conductivity of the carbon coating (typically obtained by converting a precursor such as sugar or resin via pyrolyzation) is relatively low. It would take a graphitization treatment to render the carbon coating more conductive, but this treatment requires a temperature higher than 2,000° C., which would degrade the underlying cathode active material (e.g., LiFePO₄).

As an alternative approach, Ding, et al investigated the electrochemical behavior of LiFePO₄/graphene composites [Y. Ding, et al. “Preparation of nano-structured LiFePO₄/graphene composites by co-precipitation method,” Electrochemistry Communications 12 (2010) 10-13]. The co-precipitation method leads to the formation of LiFePO₄ nanoparticles coated on both primary surfaces of graphene nanosheets. The cathode is then prepared by stacking these LiFePO₄-coated graphene sheets together. This approach has several major drawbacks: (a) with the two primary surfaces of a graphene sheet attached with LiFePO₄ nanoparticles, the resulting electrode entails many insulator-to-insulator contacts between two adjoining coated sheets in a stack; (b) only less than 30% of the graphene surface area is covered by LiFePO₄ particles on either side (This is a relatively low proportion of the cathode active material); and (c) the LiFePO₄ particles are easily detached from graphene sheets during handling and electrode production.

Several other approaches to combining graphene sheets with a cathode active material have been proposed. The most commonly used method involves dispersing graphene into a mixture of active material particles, conductive carbon, and binder to form a slurry for electrode fabrication using the conventional slurry coating procedure. For example, Jiang et al. [“Improved kinetics of LiNi_{1/3}Mn_{1/3}Co_{1/3}O₂ cathode material through reduced graphene oxide networks,” Phys. Chem. Chem. Phys., 14(2012) 2934-2939] prepared their electrode by mixing LiNi_{1/3}Mn_{1/3}Co_{1/3}O₂, reduced graphene oxide (RGO)/N-methyl-2-pyrrolidinoe (NMP) suspension, carbon black (CB), and poly(vinyl difluoride) (PVDF) at a weight ratio of 80:5:5:10. Their results showed improvements on rate capability. However, in practice, RGO can be expensive due to its high content required in an electrode and its high unit cost. In addition, it can be difficult to insure the intimate contact between active materials and RGO sheets by this simple mixing method.

Jan et al. [“Improvement of electrochemical performance of LiNi_{0.8}Co_{0.1}Mn_{0.1}O₂ cathode material by graphene nanosheets modification” Electrochimica Acta 149 (2014) 86-93] prepared their LiNi_{0.8}Co_{0.1}Mn_{0.1}O₂-graphene composite by mixing and grinding them in a mortar. The obtained mixture was then dispersed in ethanol by ultrasonication, followed by vigorously stirring at 50° C. for 8 h and drying in an oven at 80° C. overnight. The as prepared composite shows great improvement in terms of rate performances and cycle life. However, this preparation procedure can be of high costs because it uses graphene as a raw material and necessarily includes ultrasonication and drying in the synthetic route. The graphene sheets were prepared by using the conventional process that is expensive.

Such an approach was followed by Rao et al. [“LiNi_{1/3}Co_{1/3}Mn_{1/3}O₂-Graphene Composite as a Promising Cathode for Lithium-Ion Batteries,” ACS Appl. Mater. Interfaces, 3(8) (2011) 2966-2972]. Rao, et al. prepared the LiNi_{1/3}Co_{1/3}Mn_{1/3}O₂ graphene composite by mixing (i) ultrasonicated suspension of graphene powder (100 mg) in ethanol (10 mL) and (ii) LiNi_{1/3}Co_{1/3}Mn_{1/3}O₂ at a weight ratio of 90:10 and ball-milling under an argon atmosphere for 40 min at a speed of 300 rpm using a tungsten carbide vial and tungsten carbide balls. The mixture was then dried overnight at 393σK. While this method can produce homogenous mixture, the main problems are that separate procedures of graphene sheet production and high-energy ball milling may not be cost effective and high-energy ball milling can damage the original morphology of active materials. For example, LiNi_{1/3}Co_{1/3}Mn_{1/3}O₂, LiNi_{0.6}Co_{0.2}Mn_{0.2}O₂ and LiNi_{0.8}Co_{0.1}Mn_{0.1}O₂ used in industry are usually secondary particles formed by a co-precipitation synthesis method. The bonding or connection between primary particles is also too weak to maintain its shape of secondary particle when calendaring to a certain high packing density at the electrode level. In addition, for example, LiNi_{0.6}Co_{0.2}Mn_{0.2}O₂ and LiNi_{0.8}Co_{0.1}Mn_{0.1}O₂ secondary particles are usually coated with a protection layer, which could be removed or damaged during the high-energy ball milling process.

Spray drying has been an efficient way to produce well wrapped and channeled graphene/active material composites for lithium ion batteries. Vertruyen et al. reviewed most of publications with respect to spray drying of both cathode and anode materials for Li-ion and Na-ion batteries [“Spray-Drying of Electrode Materials for Lithium- and Sodium-Ion Batteries,” Materials, 11(2018) 1076-1126], and most of them has proved great improvements on both rate capability and cycle life thanks to the outstanding electrical conductivity of graphene and its protection function to prevent possible serious undesirable reaction between active materials and electrolytes in some cases.

However, typically, those reported efforts on graphene/active material composites made use of graphene oxide suspension and required post-calcination or annealing for reduction of graphene oxide in their synthesis routes. While these steps could be with no harm to most of commercial active materials, it is widely known that some advanced cathode materials such as LiNi_{0.6}Co_{0.2}Mn_{0.2}O₂ and LiNi_{0.8}Co_{0.1}Mn_{0.1}O₂ (both are often known as Ni-rich NCM) would sustain dissolution in the acidic graphene oxide suspension and certain damage in crystal structure during post-calcination or annealing in an argon environment (with or without trace amount of hydrogen). In addition, in order to form well wrapped and channeled graphene/active material composites, more than 5 wt % graphene oxide will be needed in most cases. This will add high direct cost to those cathode or anode materials, preventing them from being widely used in the market.

A single-layer graphene sheet is composed of carbon atoms occupying a two-dimensional hexagonal lattice. Multi-layer graphene is a platelet composed of more than one graphene plane. Individual single-layer graphene sheets and multi-layer graphene platelets are herein collectively called nanographene platelets (NGPs) or graphene materials. NGPs include pristine graphene (essentially 99% of carbon atoms), slightly oxidized graphene (<5% by weight of oxygen), graphene oxide (≥5% by weight of oxygen), slightly fluorinated graphene (<5% by weight of fluorine), graphene fluoride ((≥5% by weight of fluorine), other halogenated graphene, and chemically functionalized graphene.

Our research group was among the first to discover graphene [B. Z. Jang and W. C. Huang, “Nano-scaled Graphene Plates,” U.S. patent application Ser. No. 10/274,473, submitted on Oct. 21, 2002; now U.S. Pat. No. 7,071,258 (Jul. 4, 2006)]. The processes for producing NGPs and NGP nanocomposites were recently reviewed by us [Bor Z. Jang and A Zhamu, “Processing of Nano Graphene Platelets (NGPs) and NGP Nanocomposites: A Review,” J. Materials Sci. 43 (2008) 5092-5101].

The most commonly used approach to graphene production (FIG. 1) entails treating natural graphite powder with an intercalant and an oxidant (e.g., concentrated sulfuric acid and nitric acid, respectively) to obtain a graphite intercalation compound (GIC) or, actually, graphite oxide (GO). [William S. Hummers, Jr., et al., Preparation of Graphitic Oxide, Journal of the American Chemical Society, 1958, p. 1339.] Prior to intercalation or oxidation, graphite has an inter-graphene plane spacing of approximately 0.335 nm (L_{d}=½d₀₀₂=0.335 nm). With an intercalation and oxidation treatment, the inter-graphene spacing is increased to a value typically greater than 0.6 nm. This is the first expansion stage experienced by the graphite material during this chemical route. The obtained GIC or GO is then subjected to further expansion (often referred to as exfoliation) using either a thermal shock exposure or a solution-based, ultrasonication-assisted graphene layer exfoliation approach.

In the thermal shock exposure approach, the GIC or GO is exposed to a high temperature (typically 800-1,050° C.) for a short period of time (typically 15 to 60 seconds) to exfoliate or expand the GIC or GO for the formation of exfoliated or further expanded graphite, which is typically in the form of a “graphite worm” composed of graphite flakes that are still interconnected with one another. This thermal shock procedure can produce some separated graphite flakes or graphene sheets, but normally the majority of graphite flakes remain interconnected. Typically, the exfoliated graphite or graphite worm is then subjected to a flake separation treatment using air milling, mechanical shearing, or ultrasonication in water. Hence, approach 1 basically entails three distinct procedures: first expansion (oxidation or intercalation), further expansion (or “exfoliation”), and separation.

In the solution-based separation approach, the expanded or exfoliated GO powder is dispersed in water or aqueous alcohol solution, which is subjected to ultrasonication. It is important to note that in these processes, ultrasonification is used after intercalation and oxidation of graphite (i.e., after first expansion) and typically after thermal shock exposure of the resulting GIC or GO (after second expansion). Alternatively, the GO powder dispersed in water is subjected to an ion exchange or lengthy purification procedure in such a manner that the repulsive forces between ions residing in the inter-planar spaces overcome the inter-graphene van der Waals forces, resulting in graphene layer separations.

There are several major problems associated with this conventional chemical production process:
(1) The process requires the use of large quantities of several undesirable chemicals, such as sulfuric acid, nitric acid, and potassium permanganate or sodium chlorate.
(2) The chemical treatment process requires a long intercalation and oxidation time, typically 5 hours to five days.
(3) Strong acids consume a significant amount of graphite during this long intercalation or oxidation process by “eating their way into the graphite” (converting graphite into carbon dioxide, which is lost in the process). It is not unusual to lose 20-50% by weight of the graphite material immersed in strong acids and oxidizers.
(4) The thermal exfoliation requires a high temperature (typically 800-1,200° C.) and, hence, is a highly energy-intensive process.
(5) Both heat- and solution-induced exfoliation approaches require a very tedious washing and purification step. For instance, typically 2.5 kg of water is used to wash and recover 1 gram of GIC, producing huge quantities of waste water that need to be properly treated.
(6) In both the heat- and solution-induced exfoliation approaches, the resulting products are GO platelets that must undergo a further chemical reduction treatment to reduce the oxygen content. Typically even after reduction, the electrical conductivity of GO platelets remains much lower than that of pristine graphene. Furthermore, the reduction procedure often involves the utilization of toxic chemicals, such as hydrazine.
(7) Furthermore, the quantity of intercalation solution retained on the flakes after draining may range from 20 to 150 parts of solution by weight per 100 parts by weight of graphite flakes (pph) and more typically about 50 to 120 pph. During the high-temperature exfoliation, the residual intercalant species retained by the flakes decompose to produce various species of sulfuric and nitrous compounds (e.g., NOₓ and SOₓ), which are undesirable. The effluents require expensive remediation procedures in order not to have an adverse environmental impact.

Thus, an urgent need exists to have a graphene production process that requires a reduced amount of undesirable chemical (or elimination of these chemicals all together), shortened process time, less energy consumption, lower degree of graphene oxidation, reduced or eliminated effluents of undesirable chemical species into the drainage (e.g., sulfuric acid) or into the air (e.g., SO₂ and NO₂). The process should be able to produce more pristine (less oxidized and damaged), more electrically conductive, and larger/wider graphene sheets. The resulting graphene sheets must be amenable to a desired combination with an electrode active material (e.g. forming a secondary particle containing primary particles of the electrode active material being wrapped around or encapsulated by graphene sheets).

Using the lithium-ion battery and lithium metal battery as examples, these graphene sheets must be effective in (a) protecting anode active materials or cathode active materials (e.g. against volume expansion/shrinkage-induced pulverization) and the electrodes (against excessive volume changes of both anode and cathode) during repeated battery charges/discharges for improved cycle stability and (b) providing a 3D network of electron-conducting pathways without the use of an excessive amount of conductive additives that are non-active materials (those that add weight and volume to the battery without providing additional capacity of storing lithium ions).

Most desirably, a need exists for a process that is capable of producing isolated graphene sheets directly from a graphitic material and transferring the graphene sheets to wrap around or embrace the particles of an anode active material or cathode active material.

### SUMMARY OF THE INVENTION

The present invention provides a strikingly simple, fast, scalable, environmentally benign, and cost-effective method of producing graphene-embraced (graphene-encapsulated) electrode active material (either an anode active material or a cathode active material) for a wide variety of batteries. This method meets the aforementioned needs. This method entails producing single-layer or few layer graphene sheets directly from a graphitic or carbonaceous material (a graphene source material) and immediately transferring these isolated (peeled-off) graphene sheets onto surfaces of milling media particles. Subsequently, in a separate operation, these isolated (peeled-off) graphene sheets are transferred from milling media particles onto electrode active material particles to form graphene-embraced or graphene-encapsulated electrode active material particles. In an embodiment, the graphitic material or carbonaceous material has never been intercalated, oxidized, or exfoliated and does not include previously produced isolated graphene sheets.

Specifically, this invention provides a method of producing a graphene-embraced or graphene-encapsulated electrode active material directly from a graphitic material. In some embodiments, the method comprises:
a) mixing multiple particles of a graphitic material and multiple particles of a milling media to form a mixture in an impacting chamber of an energy impacting apparatus, wherein the graphitic material has never been intercalated, oxidized, or exfoliated and does not include previously produced isolated graphene sheets. The material of milling media preferably has a density from 0.5 to 9.0 g/cm³ (more preferably from 0.5 to 2.5 g/cm³) and a size less than 50 mm in diameter (preferably <10 mm, more preferably <5 mm, and most preferably <2 mm) so it will not damage the electrode active material and will have a sufficient amount of specific surface area;
b) operating the energy impacting apparatus with a frequency and an intensity for a length of time sufficient for transferring graphene sheets from the particles of graphitic material to surfaces of the milling media particles to produce a graphene-embraced milling media inside the impacting chamber (i.e., milling media particles impinge upon surfaces of graphitic material particles, peeling off graphene sheets therefrom, and naturally allowing the peeled-off graphene sheets to wrap around or embrace the milling media particles);
c) mixing multiple particles of an electrode active material and multiple particles of a milling media to form a mixture in an impacting chamber of an energy impacting apparatus (this impacting chamber may be the same as or different than the impacting chamber used in steps (a) and (b) and this energy impacting apparatus may be the same as or different than the energy impacting apparatus used in steps (a) and (b));
d) operating the energy impacting apparatus with a frequency and an intensity for a length of time sufficient for transferring graphene sheets from the particles of graphene-embraced milling media to surfaces of the solid electrode active material particles to produce a graphene-embraced electrode active material inside the impacting chamber (i.e., solid electrode active material particles impinge upon surfaces of graphene-embraced milling media, peeling off graphene sheets therefrom, and naturally allowing the peeled-off graphene sheets to fully wrap around or embrace the solid electrode active material particles); and
e) recovering the particles of graphene-embraced electrode active material from the impacting chamber (this can be as simple as removing the cap to the impacting chamber and removing the particles of graphene-embraced electrode active material).
   The method may further comprise a step of incorporating the graphene-embraced or graphene-encapsulated electrode active material into a battery electrode.

In some embodiments, the particles of solid electrode active material contain prelithiated or pre-sodiated particles. In other words, before the electrode active material particles (such as Si or SnO₂) are embraced by graphene sheets, these particles have been previously intercalated with Li or Na ions (e.g. via electrochemical charging) up to an amount of 0.1% to 30% by weight of Li or Na. This is a highly innovative and unique approach for the following considerations. The intercalation of these particles with Li or Na has allowed the Si or SnO₂ particles to expand to a large volume (potentially up to 380% of its original volume). If these prelithiated or pre-sodiated particles are then wrapped around or embraced by graphene sheets and incorporated into an electrode (i.e. anode containing graphene-embraced particles of Si or SnO₂), the electrode would no longer have any issues of electrode expansion and expansion-induced failure during subsequent charge-discharge cycles of the lithium- or sodium-ion battery. In other words, the Si or SnO₂ particles have been provided with expansion space between these particles and the embracing graphene sheets. Our experimental data have surprisingly shown that this strategy leads to significantly longer battery cycle life and more efficient utilization of the electrode active material capacity.

In some embodiments, prior to the instant “graphene transfer and embracing process,” the particles of solid electrode active material contain particles pre-coated with a coating layer of a conductive material selected from carbon, pitch, carbonized resin, a conductive polymer, a conductive organic material, a metal coating, a metal oxide shell, or a combination thereof. The coating layer thickness is preferably in the range from 1 nm to 20 μm, preferably from 10 nm to 10 μm, and further preferably from 100 nm to 1 μm.

In some embodiments, the particles of solid electrode active material contain particles that are pre-coated with a carbon precursor material selected from a coal tar pitch, petroleum pitch, mesophase pitch, polymer, organic material, or a combination thereof so that the carbon precursor material resides between surfaces of the solid electrode active material particles and the graphene sheets, and the method further contains a step of heat-treating the graphene-embraced electrode active material to convert the carbon precursor material to a carbon material and pores, wherein the pores form empty spaces between surfaces of the solid electrode active material particles and the graphene sheets, and the carbon material is coated on the surfaces of solid electrode active material particles and/or chemically bonds the graphene sheets together.

In some embodiments, the particles of solid electrode active material contain particles pre-coated with a sacrificial material selected from a metal, pitch, polymer, organic material, or a combination thereof in such a manner that the sacrificial material resides between surfaces of particles of solid electrode active material and the graphene sheets, and the method further contains a step of partially or completely removing the sacrificial material to form empty spaces between surfaces of the solid electrode active material particles and the graphene sheets.

In some embodiments, the method further comprises a step of exposing the graphene-embraced electrode active material to a liquid or vapor of a conductive material that is conductive to electrons and/or ions of lithium, sodium, magnesium, aluminum, or zinc.

The particles of electrode active material may be an anode active material selected from the group consisting of: (A) lithiated and un-lithiated silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (B) lithiated and un-lithiated alloys or intermetallic compounds of Si, Ge, Sn, Pb, Sb, Bi, Zn, Al, Ti, Ni, Co, or Cd with other elements; (C) lithiated and un-lithiated oxides, carbides, nitrides, sulfides, phosphides, selenides, and tellurides of Si, Ge, Sn, Pb, Sb, Bi, Zn, Al, Ti, Fe, Ni, Co, or Cd, and their mixtures, composites, or lithium-containing composites; (D) lithiated and un-lithiated salts and hydroxides of Sn; (E) lithium titanate, lithium manganate, lithium aluminate, lithium-containing titanium oxide, lithium transition metal oxide; and combinations thereof.

The electrode active material may be a cathode active material selected from an inorganic material, an organic or polymeric material, a metal oxide/phosphate/sulfide, or a combination thereof. The metal oxide/phosphate/sulfide may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, sodium cobalt oxide sodium nickel oxide, sodium manganese oxide, sodium vanadium oxide, sodium-mixed metal oxide, sodium iron phosphate, sodium manganese phosphate, sodium vanadium phosphate, sodium mixed metal phosphate, transition metal sulfide, lithium polysulfide, sodium polysulfide, magnesium polysulfide, or a combination thereof.

In some embodiments, the electrode active material may be a cathode active material selected from sulfur, sulfur compound, sulfur-carbon composite, sulfur-polymer composite, lithium polysulfide, transition metal dichalcogenide, a transition metal trichalcogenide, or a combination thereof. The inorganic material may be selected from TiS₂, TaS₂, MoS₂, NbSe₃, MnO₂, CoO₂, an iron oxide, a vanadium oxide, or a combination thereof.

The metal oxide/phosphate/sulfide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5. In some embodiments, the metal oxide/phosphate/sulfide is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The inorganic material may be selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The organic material or polymeric material is selected from poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, quino(triazene), redox-active organic material, tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, hexaazatrinaphtylene (HATN), hexaazatriphenylene hexacarbonitrile (HAT(CN)₆), 5-benzylidene hydantoin, isatine lithium salt, pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof. These compounds are preferably mixed with a conducting material to improve their electrical conductivity and rigidity so as to enable the peeling-off of graphene sheets from the graphitic material particles.

The thioether polymer in the above list may be selected from poly[methanetetryl-tetra(thiomethylene)] (PMTTM), poly(2,4-dithiopentanylene) (PDTP), a polymer containing poly(ethene-1,1,2,2-tetrathiol) (PETT) as a main-chain thioether polymers, a side-chain thioether polymer having a main-chain consisting of conjugating aromatic moieties, and having a thioether side chain as a pendant, poly(2-phenyl-1,3-dithiolane) (PPDT), poly(1,4-di(1,3-dithiolan-2-yl)benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene] (PEDTT).

In some embodiments, the organic material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof. These compounds are preferably mixed with a conducting material to improve their electrical conductivity and rigidity so as to enable the peeling-off of graphene sheets from the graphitic material particles.

In some embodiments, the electrode active material particles include powder, flakes, beads, pellets, spheres, wires, fibers, filaments, discs, ribbons, or rods, having a diameter or thickness from 10 nm to 20 μm. Preferably, the diameter or thickness is from 50 nm to 10 μm.

In the invented method, the graphitic material may be selected from natural graphite, synthetic graphite, highly oriented pyrolytic graphite, graphite fiber, graphitic nanofiber, graphite fluoride, chemically modified graphite, mesocarbon micro-bead, partially crystalline graphite, or a combination thereof.

The energy impacting apparatus may be a double cone mixer, vibratory ball mill, planetary ball mill, high energy mill, basket mill, agitator ball mill, cryogenic ball mill, microball mill, tumbler ball mill, attritor, continuous ball mill, stirred ball mill, pressurized ball mill, plasma-assisted ball mill, freezer mill, vibratory sieve, bead mill, nanobead mill, ultrasonic homogenizer mill, centrifugal planetary mixer, vacuum ball mill, or resonant acoustic mixer. The procedure of operating the energy impacting apparatus may be conducted in a continuous manner using a continuous energy impacting device.

In the graphene-embraced electrode active material particles, the graphene sheets may contain single-layer graphene sheets. In some embodiments, the graphene sheets contain at least 80% single-layer graphene or at least 80% few-layer graphene having no greater than 10 graphene planes.

The impacting chamber may further contain a functionalizing agent and step (b) of operating the energy impacting apparatus acts to chemically functionalize said graphene sheets with the functionalizing agent.

The present invention also provides a mass of graphene-embraced particles of solid active material produced by the aforementioned method, wherein the graphene proportion is from 0.0001% to 20% by weight based on the total weight of graphene and solid active material particles combined. The invented method is capable of producing a mass of graphene-embraced particles of solid active material, wherein the graphene proportion is from 0.0001% to 0.1% (or from 0.0001% to 0.01%) by weight based on the total weight of graphene and solid active material particles combined. It appears that no prior art method was capable of producing graphene-embraced active material particles having such a low graphene content.

Also provided is a battery electrode containing the graphene-embraced electrode active material produced according to the presently invented method, and a battery containing such an electrode. The battery electrode containing the graphene-embraced electrode active material may be a lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, or zinc-air battery.

It may be noted that the graphene production step per se (peeling off graphene sheets directly from graphite particles and immediately or concurrently transferring these graphene sheets to milling media particle surfaces) is quite surprising, considering the fact that prior researchers and manufacturers have focused on more complex, time intensive and costly methods to create graphene in industrial quantities. In other words, it has been generally believed that chemical intercalation and oxidation is needed to produce bulk quantities of isolated graphene sheets (NGPs). The present invention defies this expectation in many ways:
1. Unlike the chemical intercalation and oxidation (which requires expansion of inter-graphene spaces, further expansion or exfoliation of graphene planes, and full separation of exfoliated graphene sheets), the instant method directly removes graphene sheets from a source graphitic material and transfers these graphene sheets to surfaces of milling media and then, in a separate operation, surfaces of electrode active material particles. No undesirable chemicals (e.g. sulfuric acid and nitric acid) are used.
2. Unlike oxidation and intercalation, pristine graphene sheets, as opposed to graphene oxide sheets) can be transferred onto the electrode active material. The graphene sheets being free of oxidation damage allow the creation of graphene-encapsulated particle products with higher electrical and thermal conductivity.
3. Unlike the common production methods, a washing process requiring substantial amounts of water or solvent is not needed in the instant process.
4. Unlike bottom up production methods capable of producing only small graphene sheets, large graphene sheets can be produced with the instant method.
5. Unlike the CVD and the solution-based metalorganic production methods, respectively, elevated temperatures are not required to reduce graphene oxide to graphene and convert metalorganic compounds to pure metal. This greatly reduces the opportunity for undesirable diffusion of carbon into the electrode active material.
6. Unlike CVD and solution-based metalorganic production methods, this process is amenable to almost any electrode active material. The electrode active material does not need to be a compatible “template” or catalyst, as is required for the CVD process.
7. This method allows the creation of continuous, interpenetrating three dimensional networks of graphene sheets.
8. The present invention is amenable to industrial scale production in a continuous energy impact device.

### BRIEF DESCRIPTION OF THE DRAWINGS

FIG. 1 A flow chart showing the most commonly used prior art process of producing highly oxidized graphene sheets (or nanographene platelets, NGPs) that entails tedious chemical oxidation/intercalation, rinsing, and high-temperature exfoliation procedures.

FIG. 2 A diagram showing the presently invented process for producing graphene-embraced or graphene-encapsulated electrode active material particles via an energy impacting apparatus.

FIG. 3 A diagram showing the presently invented process for producing graphene-embraced electrode active material particles via a continuous milling device.

FIG. 4(a) Scanning electron microscope micrographs of (a) LiNi_{0.6}Co_{0.2}Mn_{0.2}O₂ particles as received.

FIG. 4(b) Scanning electron microscope micrographs of graphene embraced LiNi_{0.6}Co_{0.2}Mn_{0.2}O₂ particles. The graphene content of graphene embraced LiNi_{0.6}Co_{0.2}Mn_{0.2}O₂ particles was less than 0.5 wt %.

FIG. 5 Raman spectra of 3 random spots on graphene embraced LiNi_{0.6}Co_{0.2}Mn_{0.2}O₂ particles.

FIG. 6 X-ray diffraction patterns of (a) graphene embraced LiNi_{0.6}Co_{0.2}Mn_{0.2}O₂ particles and (b) LiNi_{0.6}Co_{0.2}Mn_{0.2}O₂ particles as received.

FIG. 7 Raman spectra of (a) LiNi_{0.8}Co_{0.1}Mn_{0.1}O₂ particles as received and (b) graphene embraced LiNi_{0.8}Co_{0.1}Mn_{0.1}O₂ particles.

FIG. 8 The charge-discharge behaviors of graphene embraced LiNi_{0.6}Co_{0.2}Mn_{0.2}O₂ particles and LiNi_{0.6}Co_{0.2}Mn_{0.2}O₂ particles as received. Three cycles were tested at each C-rate. Both samples were tested at room temperature and the cut-off voltages were 3.0 to 4.4 V.

FIG. 9 Rate performances of (a) LiNi_{0.8}Co_{0.1}Mn_{0.1}O₂ as received (electrode composition: 90% active material, 6% Super C65, and 4% PVDF); (b) graphene embraced LiNi_{0.8}Co_{0.1}Mn_{0.1}O₂ and (c) LiNi_{0.8}Co_{0.1}Mn_{0.1}O₂ as received (electrode composition of both (b) and (c): 97% active material, 1% Super C65, and 2% PVDF). Multiple half cells of each sample were tested at selected C-rates and the error bars indicated one standard deviation. All samples were tested at room temperature and the cut-off voltages were 2.5 to 4.2 V.

FIG. 10 Volumetric energy density at positive electrode level of (a) LiNi_{0.8}Co_{0.1}Mn_{0.1}O₂ as received (electrode composition: 90% active material, 6% Super C65, and 4% PVDF); (b) graphene embraced LiNi_{0.8}Co_{0.1}Mn_{0.1}O₂ and (c) LiNi_{0.8}Co_{0.1}Mn_{0.1}O₂ as received (electrode composition of both (b) and (c): 97% active material, 1% Super C65, and 2% PVDF). Multiple half cells of each sample were tested at selected C-rates and the error bars indicated one standard deviation. All samples were tested at room temperature and the cut-off voltages were 2.5 to 4.2 V.

FIG. 11 The 1^{st} cycle charge-discharge curves of (a) LiNi_{0.8}Co_{0.1}Mn_{0.1}O₂ as received (electrode composition: 90% active material, 6% Super C65, and 4% PVDF); (b) graphene embraced LiNi_{0.8}Co_{0.1}Mn_{0.1}O₂ and (c) LiNi_{0.8}Co_{0.1}Mn_{0.1}O₂ as received (electrode composition of both (b) and (c): 97% active material, 1% Super C65, and 2% PVDF).

### DETAILED DESCRIPTION OF PREFERRED EMBODIMENTS

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene sheets or basal planes that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, carbon/graphite whisker, or carbon/graphite nanofiber. In other words, graphene planes (hexagonal lattice structure of carbon atoms) constitute a significant portion of a graphite particle.

One preferred specific embodiment of the present invention is a method of peeling off graphene planes of carbon atoms (1-10 planes of atoms that are single-layer or few-layer graphene sheets) that are directly transferred to surfaces of electrode active material particles. A graphene sheet or nanographene platelet (NGP) is essentially composed of a sheet of graphene plane or multiple sheets of graphene plane stacked and bonded together (typically, on an average, less than 10 sheets per multi-layer platelet). Each graphene plane, also referred to as a graphene sheet or a hexagonal basal plane, comprises a two-dimensional hexagonal structure of carbon atoms. Each platelet has a length and a width parallel to the graphite plane and a thickness orthogonal to the graphite plane. By definition, the thickness of an NGP is 100 nanometers (nm) or smaller, with a single-sheet NGP being as thin as 0.34 nm. However, the NGPs produced with the instant methods are mostly single-layer graphene and some few-layer graphene sheets (<5 layers). The length and width of a NGP are typically between 200 nm and 20 μm, but could be longer or shorter, depending upon the sizes of source graphite material particles.

The present invention provides a strikingly simple, fast, scalable, environmentally benign, and cost-effective process for producing graphene sheets and immediately combining the produced graphene sheets and particles of an electrode active material together to form a composite or hybrid electrode active material. This process avoids essentially all of the drawbacks associated with prior art processes of producing graphene sheets and then combining graphene sheets with electrode active materials.

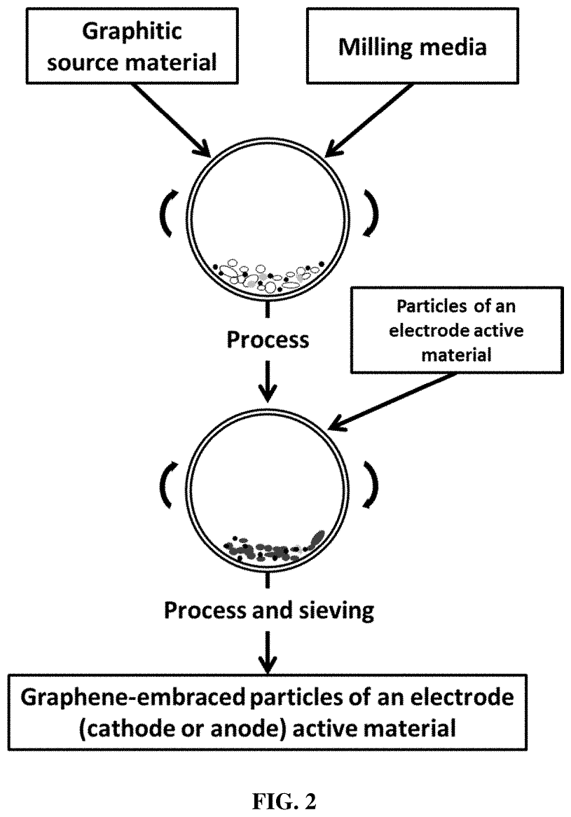

As schematically illustrated in FIG. 2, one preferred embodiment of this method entails placing particles of a source graphitic material and particles of a milling media in an impacting chamber. After loading, the resulting mixture is exposed to impacting energy, which is accomplished, for instance, by rotating the chamber to enable the impacting of the milling media particles against graphite particles. These repeated impacting events (occurring in high frequencies and high intensity) act to peel off graphene sheets from the surfaces of graphitic material particles and, immediately and directly, transfer these graphene sheets to the surfaces of the milling media particles to form graphene-embraced milling media particles. Typically, the entire milling media particle is covered by graphene sheets (fully wrapped around, embraced or encapsulated), but can be partially embraced if the impacting apparatus operating time and intensity are controlled to be short and low.

After that, multiple particles of a solid electrode active material are added into the impacting chamber and the resulting mixture is again exposed to impacting energy to enable the impacting of the active material particles against graphene-embraced milling media. Again, these repeated impacting events (occurring in high frequencies and high intensity) act to peel off graphene sheets from the surfaces of graphene-embraced milling media particles and, immediately and directly, transfer these graphene sheets to the surfaces of the active material particles to form graphene-embraced active material particles. Typically and more desirably, the entire particle is covered by graphene sheets (fully wrapped around, embraced or encapsulated).

One main difference between this invention and conventional high energy ball milling is that the milling media in the invented method is preferably selected from materials with a density of 0.5 to 2.5 g/cm³ and a size within 50 mm in diameter. The balls used in the conventional high-energy ball milling could be made of metal, Al₂O₃, or ZrO₂, which could likely result in damage of electrode active materials. Hence, the process of this invention is herein referred to as the “light media transfer” process. The present method, involving two separate and sequential graphene peeling/transferring procedures, allows for transferring of graphene sheets to softer media (e.g. plastic or rubber balls), with or without the assistance of heavier milling balls. Subsequently, these softer milling balls, during another or separate ball-milling operation, impinge upon surfaces of active material particles and transfer the surface-supported graphene sheets to active material particle surfaces. Since these milling balls are softer, they will less likely damage the active material particles, which can be fragile.

Another major advantage of the presently invented method is the flexibility in terms of selecting the most effective milling media capable of peeling off graphene sheets from different graphitic materials and the ease with which the graphene sheets coated on milling media can be peeled off and transferred to surfaces of electrode active materials.

In less than 5 hours (often less than 3 hour) of operating the light media transfer process, most of the constituent graphene sheets of source graphite particles are peeled off, forming mostly single-layer graphene and few-layer graphene (mostly less than 5 layers or 5 graphene planes). Following the light media transfer process (graphene sheets wrapped around active material particles), the milling media particles are separated from the graphene-embraced (graphene-encapsulated) particles using a broad array of methods. The resulting graphene-embraced particles are already a two-component material; i.e. they are already “mixed” and there is no need to have a separate process of mixing isolated graphene sheets with electrode active material particles.

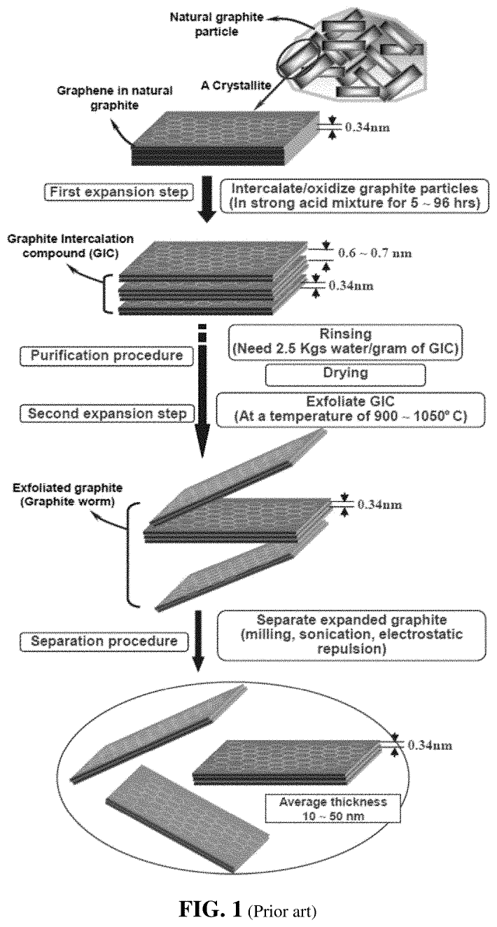

As shown in FIG. 1, the prior art chemical processes for producing graphene sheets or platelets alone typically involve immersing graphite powder in a mixture of concentrated sulfuric acid, nitric acid, and an oxidizer, such as potassium permanganate or sodium perchlorate, forming a reacting mass that requires typically 5-120 hours to complete the chemical intercalation/oxidation reaction. Once the reaction is completed, the slurry is subjected to repeated steps of rinsing and washing with water and then subjected to drying treatments to remove water. The dried powder, referred to as graphite intercalation compound (GIC) or graphite oxide (GO), is then subjected to a thermal shock treatment. This can be accomplished by placing GIC in a furnace pre-set at a temperature of typically 800-1100° C. (more typically 950-1050° C.). The resulting products are typically highly oxidized graphene (i.e. graphene oxide with a high oxygen content), which must be chemically or thermal reduced to obtain reduced graphene oxide (RGO). RGO is found to contain a high defect population and, hence, is not as conducting as pristine graphene. We have observed that that the pristine graphene paper (prepared by vacuum-assisted filtration of pristine graphene sheets, as herein prepared) exhibit electrical conductivity values in the range from 1,500-4,500 S/cm. In contrast, the RGO paper prepared by the same paper-making procedure typically exhibits electrical conductivity values in the range from 100-1,000 S/cm.

In the most common implementation of ball mill mixing, previously produced graphene sheets or platelets are added to electrode active material powders. Impact energy is applied via ball mill for a period of time to disperse graphene platelets or sheets in the powder. This is often carried out in a liquid (solvent) solution. The disadvantages of this graphene/active material mixing process are obvious—graphene is a costly input material, solvent recovery is required, and most significantly, the graphene input into the process has been damaged by oxidation during prior processing. This reduces desirable end properties, such as thermal conductivity and electrical conductivity.

Another prior art process is coating of CVD onto metal nanoparticles. This is the most limited of all prior art methods, being possible only on certain metals that are suitable catalysts for facilitating decomposition of hydrocarbon gas to form carbon atoms and as templates for graphene to grow on. As a “bottom up” graphene production method, it requires costly capital equipment and costly input materials.

In all these prior art processes for producing graphene-coated electrode active material particles, isolated graphene sheets and particles of the active material are dispersed in a solvent (e.g. NMP) to form a slurry. The slurry is then dried (e.g. using spray drying) to form graphene-active material composite particles. These composites do not necessarily have the morphology or structure of active material particles being fully wrapped around or embraced.

In contrast, the presently invented impacting process entails combining graphene production, functionalization (if desired), and mixing of graphene with electrode active material particles in a simple two-step operation. This fast and environmentally benign process not only avoids significant chemical usage, but also produces embracing graphene sheets of higher quality—pristine graphene as opposed to thermally reduced graphene oxide produced by the prior art process. Pristine graphene enables the creation of embraced particles with higher electrical and thermal conductivity.

Although the mechanisms remain incompletely understood, this revolutionary process of the present invention has essentially eliminated the conventionally required functions of graphene plane expansion, intercalant penetration, exfoliation, and separation of graphene sheets and replace it with a single, entirely mechanical exfoliation process. The whole process (FIG. 2) can take less than 5 hours (typically <3 hours) and can be done with no added chemicals. This is absolutely stunning, a shocking surprise to even those top scientists and engineers or those of extraordinary ability in the art.

Another surprising result of the present study is the observation that a wide variety of carbonaceous and graphitic materials can be directly processed without any particle size reduction or pre-treatment. The particle size of graphite can be smaller than, comparable to, or larger than the particle size of the electrode active material. The graphitic material may be selected from natural graphite, synthetic graphite, highly oriented pyrolytic graphite, mesocarbon microbead, graphite fiber, graphitic nanofiber, graphite oxide, graphite fluoride, chemically modified graphite, exfoliated graphite, or a combination thereof. It may be noted that the graphitic material used for the prior art chemical production and reduction of graphene oxide requires size reduction to 75 um or less in average particle size. This process requires size reduction equipment (for example hammer mills or screening mills), energy input, and dust mitigation. By contrast, the energy impacting device method can accept almost any size of graphitic material. A starting graphitic material of several mm or cm in size or larger or a starting material as small as nanoscaled has been successfully processed to create graphene-coated or graphene-embedded particles of cathode or anode active materials. The only size limitation is the chamber capacity of the energy impacting device; but this chamber can be very large (industry-scaled).

The presently invented process is capable of producing single-layer graphene sheets that completely wrap around the particles of an electrode active material. In many examples, the graphene sheets produced contain at least 80% single-layer graphene sheets. This could be verified by using ultrasonication to separate graphene sheets from either the milling media or the active material particles and then examining the graphene sheets using SEM, TEM, atomic force microscopy, and Raman spectroscopy. The graphene sheets produced can contain pristine graphene, oxidized graphene with less than 5% oxygen content by weight, graphene fluoride, graphene oxide with less than 5% fluorine by weight, graphene with a carbon content of no less than 95% by weight, or functionalized graphene.

The presently invented process does not involve the production of GIC and, hence, does not require the exfoliation of GIC at a high exfoliation temperature (e.g. 800-1,100° C.). This is another major advantage from environmental protection perspective. The prior art processes require the preparation of dried GICs containing sulfuric acid and nitric acid intentionally implemented in the inter-graphene spaces and, hence, necessarily involve the decomposition of H₂SO₄ and HNO₃ to produce volatile gases (e.g. NOₓ and SOₓ) that are highly regulated environmental hazards. The presently invented process completely obviates the need to decompose H₂SO₄ and HNO₃ and, hence, is environmentally benign. No undesirable gases are released into the atmosphere during the combined graphite expansion/exfoliation/separation process of the present invention.

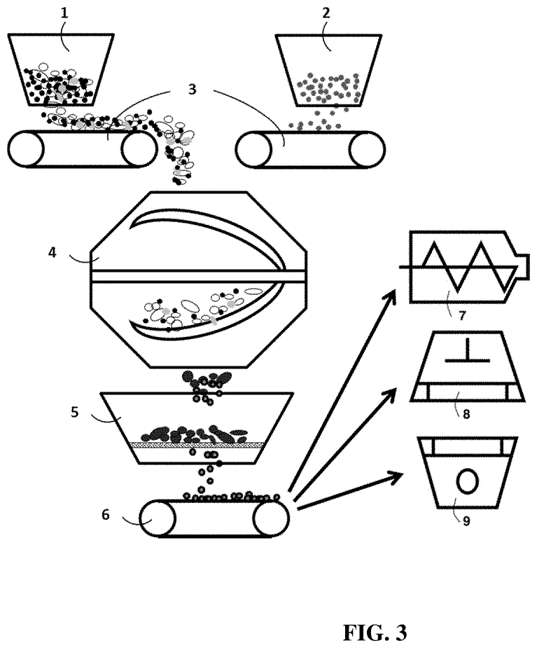

In a desired embodiment, the presently invented method is carried out in an automated and/or continuous manner. For instance, as illustrated in FIG. 3, the mixture of graphite particles and milling media particles 1 is delivered by a conveyer belt 3 and fed into a continuous double cone mixer 4. After milling to form graphene-embraced milling media particles, electrode active material particles 2 are delivered by a conveyer belt 3 and fed into a continuous double cone mixer. After milling to form graphene-embraced electrode active material particles, the product mixture is discharged from the double cone mixer 4 into a sieving device 5 to separate graphene-embraced particles from milling media particles. The graphene-embraced particles may be delivered by another conveyer belt 6 into a powder classifier, a cyclone, and or an electrostatic separator. The particles may be further processed, if so desired, by melting 7, pressing 8, or grinding/pelletizing apparatus 9. These procedures can be fully automated. The process may include characterization or classification of the output material and recycling of insufficiently processed material into the continuous energy impacting device. The process may include weight monitoring of the load in the continuous energy impacting device to optimize material properties and throughput. The used milling media can be cleaned by water, ethanol, or other solvents and be re-used after drying.

The milling media that are placed into the impacting chamber can be selected from the group consisting of polyamides (Nylon 4, Nylon 6, Nylon 6/6, Nylon 6/12, etc.), polycarbonate, polyester, polyethylene, high-density polyethylene, low-density polyethylene, polyethylene terephthalate, polypropylene, polystyrene, high impact polystyrene, polyurethanes, polyvinylchloride, polyvinylidene chloride, acrylonitrile butadiene styrene, polyepoxide, polymethyl methacrylate, polytetrafluoroethylene, phenolics (or phenol formaldehyde, melamine formaldehyde, urea-formaldehyde, polyetheretherketone, maleimide/bismaleimide, polyethrimide, polyimide, plastarch materials, polylactic acid, furan, silicone, polysulfone, natural rubber, bromo isobutylene isoprene rubber, polybutadiene, chloro isobutylene isoprene rubber, polychloroprene rubber, chlorosulphonated polyethylene, epichlorohydrin, ethylene propylene, ethylene propylene diene monomer (EPDM), fluorinated hydrocarbon rubber, fluoro silicone rubber, hydrogenated nitrile butadiene, polyisoprene rubber, isobutylene isoprene butyl rubber, methyl vinyl silicone rubber, acrylonitrile butadiene rubber, styrene butadiene rubber, styrene ethylene/butylene styrene rubber, polysiloxane rubber, polysiloxane rubber, and combinations thereof. The shape of milling media can be spherical, columnar, or any other shapes, even irregular shapes.

The electrode active materials that are placed into the impacting chamber can be an anode active material or a cathode active material. For the anode active materials, those materials capable of storing lithium ions greater than 372 mAh/g (theoretical capacity of natural graphite) are particularly desirable. Examples of these high-capacity anode active materials are Si, SiOₓ (0<x<2), Ge, Sn, SnO₂, Co₃O₄, etc. As discussed earlier, these materials, if implemented in the anode, have the tendency to expand and contract when the battery is charged and discharged. At the electrode level, the expansion and contraction of the anode active material can lead to expansion and contraction of the anode, causing mechanical instability of the battery cell. At the anode active material level, repeated expansion/contraction of particles of Si, SiOₓ, Ge, Sn, SnO₂, Co₃O₄, etc. quickly leads to pulverization of these particles and rapid capacity decay of the electrode.

Thus, for the purpose of addressing these problems, the particles of solid electrode active material may contain prelithiated or pre-sodiated particles. In other words, before the electrode active material particles (such as Si, Ge, Sn, SnO₂, Co₃O₄, etc.) are embraced by graphene sheets, these particles have already been previously intercalated with Li or Na ions (e.g. via electrochemical charging). This is a highly innovative and unique approach based on the following considerations. The intercalation of these particles with Li or Na would allow these particles to expand to a large volume or to its full capacity (potentially up to 380% of its original volume). If these prelithiated or pre-sodiated particles are then wrapped around or fully embraced by graphene sheets and incorporated into an electrode (e.g. anode containing graphene-embraced Si or SnO₂ particles), the electrode would no longer have any issues of electrode expansion and expansion-induced failure during subsequent charge-discharge cycles of the lithium- or sodium-ion battery. In other words, the Si or SnO₂ particles have been expanded to their maximum volume (during battery charging) and they can only shrink (during subsequent battery discharge). These contracted particles have been previously provided with expansion space between these particles and the embracing graphene sheets. Our experimental data have shown that this strategy surprisingly leads to significantly longer battery cycle life and better utilization of the electrode active material capacity.

In some embodiments, prior to the instant process of combined graphene production, light media transfer and embracing, the particles of solid electrode active material contain particles that are pre-coated with a coating of a conductive material selected from carbon, pitch, carbonized resin, a conductive polymer, a conductive organic material, a metal coating, a metal oxide shell, or a combination thereof. The coating layer thickness is preferably in the range from 1 nm to 10 μm, preferably from 5 nm to 1 μm, and further preferably from 10 nm to 200 nm. This coating is implemented for the purpose of establishing a solid-electrolyte interface (SEI) to increase the useful cycle life of a lithium-ion or sodium-ion battery.

In some embodiments, the particles of solid electrode active material contain particles that are pre-coated with a carbon precursor material selected from a coal tar pitch, petroleum pitch, mesophase pitch, polymer, organic material, or a combination thereof so that the carbon precursor material resides between surfaces of the solid electrode active material particles and the graphene sheets, and the method further contains a step of heat-treating the graphene-embraced electrode active material to convert the carbon precursor material to a carbon material and pores, wherein the pores form empty spaces between surfaces of the solid electrode active material particles and the graphene sheets and the carbon material is coated on the surfaces of solid electrode active material particles and/or chemically bonds the graphene sheets together. The carbon material helps to completely seal off the embracing graphene sheets to prevent direct contact of the embraced anode active material with liquid electrolyte, which otherwise continues to form additional SEI via continuously consuming the lithium ions or solvent in the electrolyte, leading to rapid capacity decay.

In some embodiments, the particles of solid electrode active material contain particles pre-coated with a sacrificial material selected from a metal, pitch, polymer, organic material, or a combination thereof in such a manner that the sacrificial material resides between surfaces of solid electrode active material particles and the graphene sheets, and the method further contains a step of partially or completely removing the sacrificial material to form empty spaces between surfaces of the solid electrode active material particles and the graphene sheets. The empty spaces can accommodate the expansion of embraced active material particles without breaking the embraced particles.

In some embodiments, the method further comprises a step of exposing the graphene-embraced electrode active material to a liquid or vapor of a conductive material that is conductive to electrons and/or ions of lithium, sodium, magnesium, aluminum, or zinc. This procedure serves to provide a stable SEI or to make the SEI more stable.

The particles of electrode active material may be an anode active material selected from the group consisting of: (A) lithiated and un-lithiated silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (B) lithiated and un-lithiated alloys or intermetallic compounds of Si, Ge, Sn, Pb, Sb, Bi, Zn, Al, Ti, Ni, Co, or Cd with other elements; (C) lithiated and un-lithiated oxides, carbides, nitrides, sulfides, phosphides, selenides, and tellurides of Si, Ge, Sn, Pb, Sb, Bi, Zn, Al, Ti, Fe, Ni, Co, or Cd, and their mixtures, composites, or lithium-containing composites; (D) lithiated and un-lithiated salts and hydroxides of Sn; (E) lithium titanate, lithium manganate, lithium aluminate, lithium-containing titanium oxide, lithium transition metal oxide; and combinations thereof. Both sodiated and un-sodiated versions of the materials in the above list are also anode active materials for sodium-ion batteries.

The electrode active material may be a cathode active material selected from an inorganic material, an organic material, an intrinsically conducting polymer (known to be capable of string lithium ions), a metal oxide/phosphate/sulfide, or a combination thereof. The metal oxide/phosphate/sulfide may be selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, sodium cobalt oxide sodium nickel oxide, sodium manganese oxide, sodium vanadium oxide, sodium-mixed metal oxide, sodium iron phosphate, sodium manganese phosphate, sodium vanadium phosphate, sodium mixed metal phosphate, transition metal sulfide, lithium polysulfide, sodium polysulfide, magnesium polysulfide, or a combination thereof.

In some embodiments, the electrode active material may be a cathode active material selected from sulfur, sulfur compound, sulfur-carbon composite, sulfur-polymer composite, lithium polysulfide, transition metal dichalcogenide, a transition metal trichalcogenide, or a combination thereof. The inorganic material may be selected from TiS₂, TaS₂, MoS₂, NbSe₃, MnO₂, CoO₂, an iron oxide, a vanadium oxide, or a combination thereof. This group of materials is particularly suitable for use as a cathode active material of a lithium metal battery.

The metal oxide/phosphate/sulfide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5. In some embodiments, the metal oxide/phosphate/sulfide is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

The inorganic material may be selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

The organic material or polymeric material may be selected from poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, quino(triazene), redox-active organic material, tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, hexaazatrinaphtylene (HATN), hexaazatriphenylene hexacarbonitrile (HAT(CN)₆), 5-benzylidene hydantoin, isatine lithium salt, pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof. These compounds are preferably mixed with a conducting material to improve their electrical conductivity, rigidity and strength so as to enable the peeling-off of graphene sheets from the graphitic material particles.

The thioether polymer in the above list may be selected from poly[methanetetryl-tetra(thiomethylene)] (PMTTM), poly(2,4-dithiopentanylene) (PDTP), a polymer containing poly(ethene-1,1,2,2-tetrathiol) (PETT) as a main-chain thioether polymers, a side-chain thioether polymer having a main-chain consisting of conjugating aromatic moieties, and having a thioether side chain as a pendant, poly(2-phenyl-1,3-dithiolane) (PPDT), poly(1,4-di(1,3-dithiolan-2-yl) benzene) (PDDTB), poly(tetrahydrobenzodithiophene) (PTHBDT), poly[1,2,4,5-tetrakis(propylthio)benzene] (PTKPTB, or poly[3,4(ethylenedithio)thiophene] (PEDTT).

In some embodiments, the organic material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof. These compounds are preferably mixed with a conducting material to improve their electrical conductivity and rigidity so as to enable the peeling-off of graphene sheets from the graphitic material particles.

In some embodiments, the electrode active material particles include powder, flakes, beads, pellets, spheres, wires, fibers, filaments, discs, ribbons, or rods, having a diameter or thickness from 10 nm to 20 μm. Preferably, the diameter or thickness is from 20 nm to 10 μm.

In the invented method, the graphitic material may be selected from natural graphite, synthetic graphite, highly oriented pyrolytic graphite, graphite fiber, graphitic nanofiber, graphite fluoride, chemically modified graphite, mesocarbon microbead, partially crystalline graphite, or a combination thereof.

The energy impacting apparatus may be a vibratory ball mill, planetary ball mill, high energy mill, basket mill, agitator ball mill, cryogenic ball mill, microball mill, tumbler ball mill, attritor, continuous ball mill, stirred ball mill, pressurized ball mill, plasma-assisted ball mill, freezer mill, vibratory sieve, bead mill, nanobead mill, ultrasonic homogenizer mill, centrifugal planetary mixer, vacuum ball mill, or resonant acoustic mixer. The procedure of operating the energy impacting apparatus may be conducted in a continuous manner using a continuous energy impacting device

Graphene sheets transferred to electrode active material surfaces have a significant proportion of surfaces that correspond to the edge planes of graphite crystals. The carbon atoms at the edge planes are reactive and must contain some heteroatom or group to satisfy carbon valency. There are many types of functional groups (e.g. hydroxyl and carboxylic) that are naturally present at the edge or surface of graphene nanoplatelets produced through transfer to a solid carrier particle. The impact-induced kinetic energy is of sufficient energy and intensity to chemically activate the edges and even surfaces of graphene sheets embraced around active material particles (e.g. creating highly active sites or free radicals). Provided that certain chemical species containing desired chemical function groups (e.g. OH—, —COOH, —NH₂, Br—, etc.) are included in the impacting chamber, these functional groups can be imparted to graphene edges and/or surfaces. In other words, production and chemical functionalization of graphene sheets can be accomplished concurrently by including appropriate chemical compounds in the impacting chamber. In summary, a major advantage of the present invention over other processes is the simplicity of simultaneous production and modification of graphene surface chemistry for improved battery performance.

Graphene platelets derived by this process may be functionalized through the inclusion of various chemical species in the impacting chamber. In each group of chemical species discussed below, we selected 2 or 3 chemical species for functionalization studies.

In one preferred group of chemical agents, the resulting functionalized NGP may broadly have the following formula (e): [NGP]—Rₘ, wherein m is the number of different functional group types (typically between 1 and 5), R is selected from SO₃H, COOH, NH₂, OH, R′CHOH, CHO, CN, COCl, halide, COSH, SH, COOR′, SR′, SiR′₃, Si(—OR′—)_{y}R′_{3-y}, Si(—O—SiR′₂—)OR′, R″, Li, AlR′₂, Hg—X, TlZ₂ and Mg—X; wherein y is an integer equal to or less than 3, R′ is hydrogen, alkyl, aryl, cycloalkyl, or aralkyl, cycloaryl, or poly(alkylether), R″ is fluoroalkyl, fluoroaryl, fluorocycloalkyl, fluoroaralkyl or cycloaryl, X is halide, and Z is carboxylate or trifluoroacetate.

Graphene-embraced electrode active material particles may be used to improve the mechanical properties, electrical conductivity and thermal conductivity of an electrode. For enhanced lithium-capturing and storing capability, the functional group —NH₂ and —OH are of particular interest. For example, diethylenetriamine (DETA) has three —NH₂ groups. If DETA is included in the impacting chamber, one of the three —NH₂ groups may be bonded to the edge or surface of a graphene sheet and the remaining two un-reacted —NH₂ groups will be available for reversibly capturing a lithium or sodium atom and forming a redox pair therewith. Such an arrangement provides an additional mechanism for storing lithium or sodium ions in a battery electrode.

Other useful chemical functional groups or reactive molecules may be selected from the group consisting of amidoamines, polyamides, aliphatic amines, modified aliphatic amines, cycloaliphatic amines, aromatic amines, anhydrides, ketimines, diethylenetriamine (DETA), triethylene-tetramine (TETA), tetraethylene-pentamine (TEPA), hexamethylenetetramine, polyethylene polyamine, polyamine epoxy adduct, phenolic hardener, non-brominated curing agent, non-amine curatives, and combinations thereof. These functional groups are multi-functional, with the capability of reacting with at least two chemical species from at least two ends. Most importantly, they are capable of bonding to the edge or surface of graphene using one of their ends and, during subsequent epoxy curing stage, are able to react with epoxide or epoxy resin material at one or two other ends.

The above-described [NGP]—Rₘ may be further functionalized. This can be conducted by opening up the lid of an impacting chamber after the —Rₘ groups have been attached to graphene sheets and then adding the new functionalizing agents to the impacting chamber and resuming the impacting operation. The resulting graphene sheets or platelets include compositions of the formula: [NGP]--Aₘ, where A is selected from OY, NHY, O═C—OY, P═C—NR′Y, O═C—SY, O═C—Y, —CR′1--OY, N′Y or C′Y, and Y is an appropriate functional group of a protein, a peptide, an amino acid, an enzyme, an antibody, a nucleotide, an oligonucleotide, an antigen, or an enzyme substrate, enzyme inhibitor or the transition state analog of an enzyme substrate or is selected from R′—OH, R′—NR′₂, R′SH, R′CHO, R′CN, R′X, R′N⁺(R′)₃X⁻, R′SiR′₃, R′Si(—OR′—)_{y}R′_{3-y}, R′Si(—O—SiR′₂—)OR′, R′—R″, R′—N—CO, (C₂H₄O—)_{w}H, (—C₃H₆O—)_{w}H, (—C₂H₄O)_{w}—R′, (C₃H₆O)_{w}—R′, R′, and w is an integer greater than one and less than 200.

The NGPs may also be functionalized to produce compositions having the formula: [NGP]—[R′--A]ₘ, where m, R′ and A are as defined above. The compositions of the invention also include NGPs upon which certain cyclic compounds are adsorbed. These include compositions of matter of the formula: [NGP]—[X—Rₐ]ₘ, where a is zero or a number less than 10, X is a polynuclear aromatic, polyheteronuclear aromatic or metallopolyheteronuclear aromatic moiety and R is as defined above. Preferred cyclic compounds are planar. More preferred cyclic compounds for adsorption are porphyrins and phthalocyanines. The adsorbed cyclic compounds may be functionalized. Such compositions include compounds of the formula, [NGP]—[X—Aₐ]ₘ, where m, a, X and A are as defined above.

The functionalized NGPs of the instant invention can be prepared by sulfonation, electrophilic addition to deoxygenated platelet surfaces, or metallation. The graphitic platelets can be processed prior to being contacted with a functionalizing agent. Such processing may include dispersing the platelets in a solvent. In some instances the platelets may then be filtered and dried prior to contact. One particularly useful type of functional group is the carboxylic acid moieties, which naturally exist on the surfaces of NGPs if they are prepared from the acid intercalation route discussed earlier. If carboxylic acid functionalization is needed, the NGPs may be subjected to chlorate, nitric acid, or ammonium persulfate oxidation.

Carboxylic acid functionalized graphitic platelets are particularly useful because they can serve as the starting point for preparing other types of functionalized NGPs. For example, alcohols or amides can be easily linked to the acid to give stable esters or amides. If the alcohol or amine is part of a di- or poly-functional molecule, then linkage through the O- or NH-leaves the other functionalities as pendant groups. These reactions can be carried out using any of the methods developed for esterifying or aminating carboxylic acids with alcohols or amines as known in the art. Examples of these methods can be found in G. W. Anderson, et al., J. Amer. Chem. Soc. 86, 1839 (1964), which is hereby incorporated by reference in its entirety. Amino groups can be introduced directly onto graphitic platelets by treating the platelets with nitric acid and sulfuric acid to obtain nitrated platelets, then chemically reducing the nitrated form with a reducing agent, such as sodium dithionite, to obtain amino-functionalized platelets. Functionalization of the graphene-coated inorganic particles may be used as a method to introduce dopants into the electrode active material.

The following examples serve to provide the best modes of practice for the present invention and should not be construed as limiting the scope of the invention:

### Example 1: Graphene Embraced Particles of Electrode Active Materials

Several types of electrode active materials (both anode and cathode active materials) in a fine powder form were investigated. These include Co₃O₄, Si, LiCoO₂, LiMn₂O₄, lithium iron phosphate, etc., which are used as examples to illustrate the best mode of practice. These active materials either were prepared in house or were commercially available.

In a typical experiment, 100 grams of natural flake graphite, 50 mesh (average particle size 0.18 mm; Asbury Carbons, Asbury N.J.) and 1 kg of polyethylene terephthalate (PET) pellets were placed in a high-energy ball mill container. The ball mill was operated at 300 rpm for 0.5 to 4 hours. The container lid was then removed and PET pellets were found to be encapsulated by graphene sheets. Subsequently, the residual graphite particles were removed from the ball mill container. Then, 1 kg of electrode active material powder was added into the ball mill container having graphene-encapsulated PET particles residing therein. The ball mill was then operated for another 10 minutes to 2 hours. The particles of the active materials were found to be fully coated (embraced or encapsulated) with a dark layer of graphene as verified by SEM, TEM, and Raman spectroscopy. The mass of processed material was placed over a 50 mesh sieve and, in some cases, a small amount of unprocessed flake graphite was removed.

### Example 2: Graphene-Embraced SnO₂ Particles

In an experiment, 2 grams of Nylon 6/6 particles and 0.25 grams of artificial graphite (obtained by graphitization of needle coke) were placed in a tumbler mill and processed for 2 hours. Then, residual graphite particles were separated from the graphene-coated Nylon particles. Subsequently, 2 grams of 99.9% purity tin oxide powder (90 nm diameter) and the graphene-coated Nylon particles were poured into the same tumbler mill, which was operated for 0.5 to 2 hours to obtain graphene-embraced tin oxide particles.

For comparison, a mixture of 2 grams of Nylon 6/6 particles, 2 grams of 99.9% purity tin oxide powder, and 0.25 grams of artificial graphite was placed in the same tumbler mill, which was operated for 0.5-4 hours. We have observed that both tin oxide particles and Nylon particles were embraced with graphene sheets. In other words, some graphene sheets were wrapped around Nylon particles, instead of being wrapped around tin oxide particles. We have further observed that it would take a significantly longer time to complete the production of graphene-embraced tine oxide particles by using this latter process. Further, as compared to the instant process, this latter process also led to graphene-coated active material particles (SnO₂, Si, SiO, etc.), wherein the thickness of the graphene coating had a broader distribution between particles (i.e. less uniform distribution). This also appeared to result in less consistent battery cycle life.

### Example 3: Graphene-Encapsulated Si Micron Particles

In a first experiment, 500 grams of SiO₂ particles (as a ball milling medium) and 50 grams of highly oriented pyrolytic graphite (HOPG) were placed in a high-intensity ball mill. The mill was operated for 20 minutes, after which the container lid was opened and un-processed HOPG was removed by a 50 mesh sieve. It was observed that SiO₂ particles were embraced with graphene sheets. Subsequently, graphene-coated SiO₂ particles were separated from unused HOPG particles and mixed with 500 g of Si powder (particle diameter ˜3 μm) in a high-intensity ball mill, which was operated for a period from 5 minutes to 1 hour. The Si particles were coated with a dark layer, which was verified to be graphene by Raman spectroscopy.

In a second experiment, the same type of experiment was conducted with the exception that polyethylene-coated Si particles were used. Micron-scaled Si particles from the same batch were pre-coated with a layer of polyethylene (PE) using a micro-encapsulation method that includes preparing solution of PE dissolved in toluene, dispersing Si particles in this solution to form a slurry, and spry-drying the slurry to form PE-encapsulated Si particles. Then, a mixture of 500 g of PE-encapsulated Si particles and 500 grams of graphene-coated SiO₂ particles were placed in a high-intensity ball mill. The mill was operated for 20 minutes, after which the container lid was opened. The PE-encapsulated Si particles (PE layer varied from 0.3 to 2.0 μm) were now also embraced with graphene sheets. These graphene-embraced PE-encapsulated particles were then subjected to a heat treatment (up to 600° C.) that converted PE to carbon. The converted carbon was mostly deposited on the exterior surface of the Si particles, leaving behind a gap or pores between the Si particle surface and the encapsulating graphene shell. This gap provides room to accommodate the volume expansion of the Si particle when the lithium-ion battery is charged. Such a strategy leads to significantly improved battery cycle life.

In a third experiment, the Si particles were subjected to electrochemical prelithiation to prepare several samples containing from 5% to 54% Li. Prelithiation of an electrode active material means the material is intercalated or loaded with lithium before a battery cell is made. Various prelithiated Si particles were then subjected to the presently invented graphene encapsulation treatment. The resulting graphene-encapsulated prelithiated Si particles were incorporated as an anode active material in several lithium-ion cells.

### Example 4: Graphene-Embraced Ge Particles (Using Mesocarbon Microbeads, MCMBs, as the Graphene Source)

In one example, 200 grams of Zirconia (as a ball milling medium) and 10 grams of MCMBs (China Steel Chemical Co., Taiwan) were placed in a low-intensity ball mill, and processed for 5 minutes to 3 hours to obtain graphene-coated zirconia. Un-processed MCMB particles were removed by sieving, air classification, and settling in a solvent solution. A mixture of 500 grams of B-doped Ge powder (an anode active material) and 200 grams of graphene-coated zirconia were loaded into a ball milling chamber of a low-intensity ball mill, which was operated for 2-60 minutes to obtain graphene-embraced Ge particles having a graphene content from 0.0001% to 0.2% by weight.

### Example 5: Graphene-Encapsulated Lithium Iron Phosphate (LFP) as a Cathode Active Material for a Lithium Metal Battery

LFP powder, un-coated or carbon-coated, is commercially available from several sources. Polylactic acid (PLA) particles and natural graphite particles were mixed in ball mill pots of a high-intensity ball mill apparatus, which was operated for 0.5-2 hours to produce graphene-coated PLA particles. The carbon-coated LFP powder and un-coated LFP powder samples were separately mixed with the graphene-coated PLA particles and loaded into the ball milling pots of the same ball mill apparatus. The apparatus was operated for 10-60 minutes for each LFP material to produce graphene-encapsulated carbon-coated LFP powder and un-coated LFP powder samples, respectively.

### Example 6: Graphene Embraced Plastic Milling Media in a Double-Cone Mixer (Mill)

Several types of plastic milling media in spherical or irregular shapes were investigated. These include polyethylene terephthalate, nylon 6, and polylactic acid, etc., which are used as examples to illustrate the best mode of practice. In a typical experiment, 5 kg of plastic milling media (average particle size 4.5 mm) and 10-100 grams of natural flake graphite, 50 mesh (average particle size 0.18 mm; Asbury Carbons, Asbury N.J.) were placed in a double cone mixer. The double cone mixer was operated at 60 rpm for 0.5 to 4 hours and the plastic milling media were found to be fully coated (embraced or encapsulated) with a dark layer, which was verified to be graphene by Raman spectroscopy. The graphene-embraced plastic media were then mixed with particles of various cathode active materials and processed with a double-cone mill to produce graphene-embraced cathode active materials.

### Example 7: Graphene-Encapsulated V₂O₅ as an Example of a Transition Metal Oxide Cathode Active Material of a Lithium Battery

V₂O₅ powder is commercially available. A mixture of small copper balls and natural graphite was sealed in each of 4 ball milling pots symmetrically positioned in a high-intensity ball mill. The mill was operated for 1 hour to produce particulates of graphene-encapsulated Cu particles. The graphene-coated Cu particles and V₂O₅ particles were then loaded into an attritor mill, which was operated for 0.1-1 hour to produce graphene-coated V₂O₅ particles. These graphene-encapsulated V₂O₅ particles were implemented as the cathode active material in a lithium metal battery.

### Example 8: LiCoO₂ as an Example of Lithium Transition Metal Oxide Cathode Active Material for a Lithium-Ion Battery

The same experiment, as described in Example 7, was conducted for LiCoO₂ particles to produce particulates of graphene-encapsulated LiCoO₂ particles.

### Example 9: Organic Material (Li₂C₆O₆) as a Cathode Active Material of a Lithium Metal Battery

The experiments associated with this example were conducted to determine if organic materials, such as Li₂C₆O₆, can be encapsulated in graphene sheets using the presently invented method. Soft organic active materials alone are typically incapable of peeling off graphene sheets from graphite particles. However, if particles of a plastic-based milling media are coated with graphene sheets as described in the instant application, these graphene-coated plastic particles are capable of transferring graphene sheets to surfaces of the organic active material particles in a ball milling pot.

In order to synthesize dilithium rhodizonate (Li₂C₆O₆), the rhodizonic acid dihydrate (species 1 in the following scheme) was used as a precursor. A basic lithium salt, Li₂CO₃ can be used in aqueous media to neutralize both enediolic acid functions. Strictly stoichiometric quantities of both reactants, rhodizonic acid and lithium carbonate, were allowed to react for 10 hours to achieve a yield of 90%. Dilithium rhodizonate (species 2) was readily soluble even in a small amount of water, implying that water molecules are present in species 2. Water was removed in a vacuum at 180° C. for 3 hours to obtain the anhydrous version (species 3).

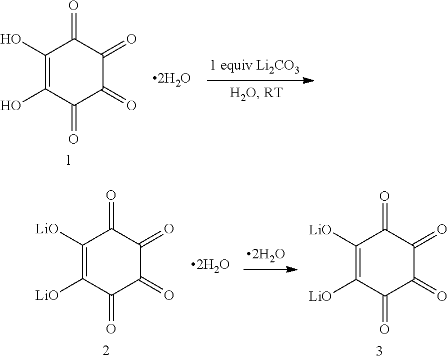

The same procedure as in Example 6 were followed to produce graphene-encapsulated Li₂C₆O₆ particles.

It may be noted that the two Li atoms in the formula Li₂C₆O₆ are part of the fixed structure and they do not participate in reversible lithium ion storing and releasing. This implies that lithium ions must come from the anode side. Hence, there must be a lithium source (e.g. lithium metal or lithium metal alloy) at the anode. In one battery cell herein tested, the anode current collector (Cu foil) is deposited with a layer of lithium (via sputtering). The resulting cell is a lithium metal cell.

### Example 10: Graphene-Encapsulated Na₃V₂(PO₄)₃/C and Na₃V₂(PO₄)₃ Cathodes for Sodium Metal Batteries

The Na₃V₂(PO₄)₃/C sample was synthesized by a solid state reaction according to the following procedure: a stoichiometric mixture of NaH₂PO₄.2H₂O (99.9%, Alpha) and V₂O₃ (99.9%, Alpha) powders was put in an agate jar as a precursor and then the precursor was ball-milled in a planetary ball mill at 400 rpm in a stainless steel vessel for 8 h. During ball milling, for the carbon coated sample, sugar (99.9%, Alpha) was also added as the carbon precursor and the reductive agent, which prevents the oxidation of V3⁺. After ball milling, the mixture was heated at 900° C. for 24 h in Ar atmosphere. Separately, the Na₃V₂(PO₄)₃ powder was prepared in a similar manner, but without sugar. Samples of both powders were then subjected to ball milling in the presence of graphene-coated plastic beads to prepare graphene-encapsulated Na₃V₂(PO₄)₃ particles and graphene-encapsulated carbon-coated Na₃V₂(PO₄)₃ particles according to a procedure similar to that in Example 2. The cathode active materials were used in several Na metal cells containing 1 M of NaPF₆ salt in PC+DOL as the electrolyte. It was discovered that graphene encapsulation significantly improved the cycle stability of all Na metal cells studied. In terms of cycle life, the following sequence was observed: graphene-encapsulated Na₃V₂(PO₄)₃/C>graphene-encapsulated Na₃V₂(PO₄)₃>Na₃V₂(PO₄)₃/C>Na₃V₂(PO₄)₃.

### Example 11: Preparation of Graphene-Encapsulated MoS₂ Particles as a Cathode Active Material of a Na Metal Battery

A wide variety of inorganic materials were investigated in this example. For instance, an ultra-thin MoS₂ material was synthesized by a one-step solvothermal reaction of (NH₄)₂MoS₄ and hydrazine in N, N-dimethylformamide (DMF) at 200° C. In a typical procedure, 22 mg of (NH₄)₂MoS₄ was added to 10 ml of DMF. The mixture was sonicated at room temperature for approximately 10 min until a clear and homogeneous solution was obtained. After that, 0.1 ml of N₂H₄.H₂O was added. The reaction solution was further sonicated for 30 min before being transferred to a 40 mL Teflon-lined autoclave. The system was heated in an oven at 200° C. for 10 h. Product was collected by centrifugation at 8000 rpm for 5 min, washed with DI water and recollected by centrifugation. The washing step was repeated for 5 times to ensure that most DMF was removed. Finally, MoS₂ particles were dried and subjected to graphene encapsulation by following the same procedure described in Example 4.

### Example 12: Preparation of Two-Dimensional (2D) Layered Bi₂Se₃ Chalcogenide Nanoribbons

The preparation of (2D) layered Bi₂Se₃ chalcogenide nanoribbons is well-known in the art. In the present study, Bi₂Se₃ nanoribbons were grown using the vapor-liquid-solid (VLS) method. Nanoribbons herein produced are, on average, 30-55 nm thick with widths and lengths ranging from hundreds of nanometers to several micrometers. Larger nanoribbons were subjected to ball-milling for reducing the lateral dimensions (length and width) to below 200 nm. Nanoribbons prepared by these procedures were subjected to graphene encapsulation using the presently invented method, as described in Example 3. The graphene-encapsulated Bi₂Se₃ nanoribbons were used as a cathode active material for Na battery. Surprisingly, Bi₂Se₃ chalcogenide nanoribbons are capable of storing Na ions on their surfaces.

### Example 13: Preparation of Graphene-Encapsulated MnO₂ and NaMnO₂ Cathode Active Material for Na Metal Cells and Zn Metal Cells

For the preparation of the MnO₂ powder, a 0.1 mol/L KMnO₄ aqueous solution was prepared by dissolving potassium permanganate in deionized water. Meanwhile, 13.32 g surfactant of high purity sodium bis(2-ethylhexyl) sulfosuccinate was added in 300 mL iso-octane (oil) and stirred well to get an optically transparent solution. Then, 32.4 mL of 0.1 mol/L KMnO₄ solution was added into the solution, which was ultrasonicated for 30 min to prepare a dark brown precipitate. The product was separated, washed several times with distilled water and ethanol, and dried at 80° C. for 12 h. Some amount of the MnO₂ powder was then subjected to the graphene encapsulation treatment as described in Example 5 to obtain graphene-encapsulated MnO₂ particles.

Additionally, NaMnO₂ particles were synthesized by ball-milling a mixture of Na₂CO₃ and MnO₂ (at a molar ratio of 1:2) for 12 h followed by heating at 870° C. for 10 h. The resulting NaMnO₂ particles were then subjected to ball-milling, as described in Example 6, to prepare graphene encapsulated NaMnO₂ particles.

The MnO₂ particles, with or without graphene encapsulation, are also incorporated in alkaline Zn/MnO₂ cells. Graphene encapsulation was found to dramatically increase the cycle life of this type of cell. The Zn-graphene/MnO₂ battery is composed of a graphene/MnO₂-based cathode (with an optional cathode current collector and an optional conductive filler), a Zn metal or alloy-based anode (with an optional anode current collector), and an aqueous electrolyte (e.g. a mixture of a mild ZnSO₄ or Zn(NO₃)₂ with MnSO₄ in water).

### Example 14: Layered Zinc Hydroxide Salts Encapsulated by Graphene Sheets as the Hybrid Cathode Material

The structural arrangements of dodecyl sulfate (DS) anions in the interlayer space of layered zinc hydroxide salts (LZH-DS) and of the structure of zinc hydroxide layers were investigated. As-prepared, highly crystalline LZH-DS has a basal spacing of 31.5 Å (3.15 nm). After treatment with methanol at room temperature, zinc hydroxide layers shrank to form two new layered phases with basal spacings of 26.4 and 24.7 Å. The shrinking was accompanied by a decrease in the content of DS anions in the interlayer space, indicating a change in the alignment of the intercalated anions and a decrease in the charge density of the zinc hydroxide layers. This study indicates that tetrahedra Zn ions can be reversibly removed from the hydroxide layers, with the octahedrally coordinated Zn ions left unaffected. This result suggests that layered zinc hydroxide can be used as a Zn intercalation compound. In the present investigation, layered zinc hydroxide particles were also subjected to ball milling, as described in Example 6, resulting in the formation of graphene-encapsulated zinc hydroxide particles. It was discovered that graphene encapsulation imparts high-rate capability to the layered zinc hydroxide when used as a cathode active material of a Zn metal cell.

### Example 15: Graphene Embraced LiNi_{0.6}Co_{0.2}Mn_{0.2}O₂ Particles

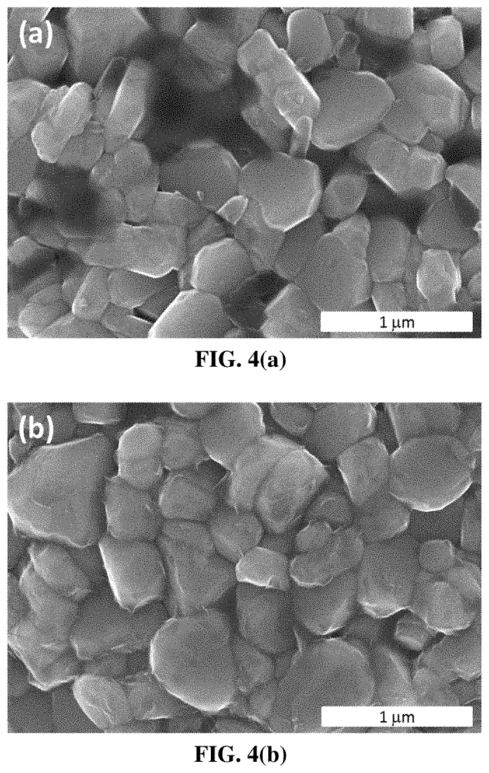

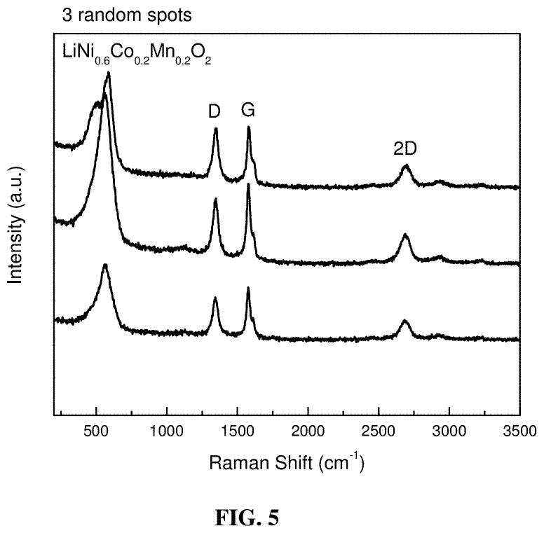

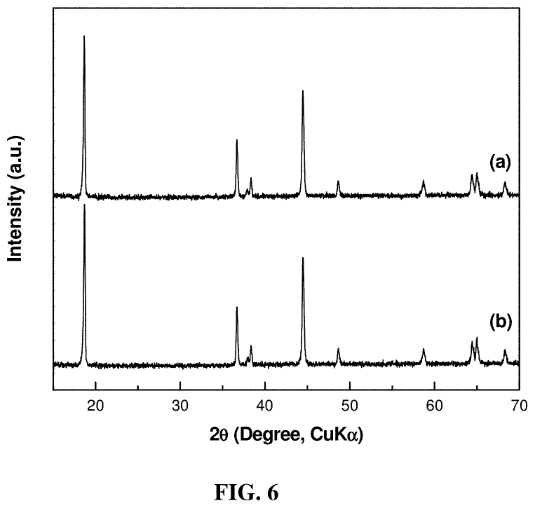

In an experiment, 50 to 200 grams of graphene-embraced plastic milling media and 5 to 20 grams of LiNi_{0.6}Co_{0.2}Mn_{0.2}O₂ particles (D50=10 μm; Toda America) were placed in a ball milling machine and processed at 100 rpm for 20 minutes. After that, graphene embraced plastic milling media and graphene embraced LiNi_{0.6}Co_{0.2}Mn_{0.2}O₂ particles were separated by sieving. The as-prepared graphene-embraced LiNi_{0.6}Co_{0.2}Mn_{0.2}O₂ particles were examined by a scanning electron microscope and, as shown in FIG. 4(b), graphene that embraced LiNi_{0.6}Co_{0.2}Mn_{0.2}O₂ particles has been clearly observed. Raman spectroscopy was used to check the graphene quality embraced on LiNi_{0.6}Co_{0.2}Mn_{0.2}O₂ particles, and the results from multiple points detected were shown in FIG. 5 that proved the graphene on surface of LiNi_{0.6}Co_{0.2}Mn_{0.2}O₂ particles was of single to few layers by comparing intensities of D-, G- and 2D-band peaks. Furthermore, comparing to the X-ray diffraction pattern of LiNi_{0.6}Co_{0.2}Mn_{0.2}O₂ particles as received (FIG. 6, Curve a), graphene embraced LiNi_{0.6}Co_{0.2}Mn_{0.2}O₂ particles did not show any change crystallographically (FIG. 6, Curve b). That is, this invention indeed provides a method that can effectively embrace graphene on particles without damaging their crystal structures, which is not the case if high-energy ball milling is used directly. The graphene content embraced on LiNi_{0.6}Co_{0.2}Mn_{0.2}O₂ can be varied by tuning processing time, rotation speed, or milling-media-to-LiNi_{0.6}Co_{0.2}Mn_{0.2}O₂ ratio. Typical value of graphene content in this example was <0.5 wt %.

### Example 16: Graphene Embraced LiNi_{0.8}Co_{0.1}Mn_{0.1}O₂ Particles

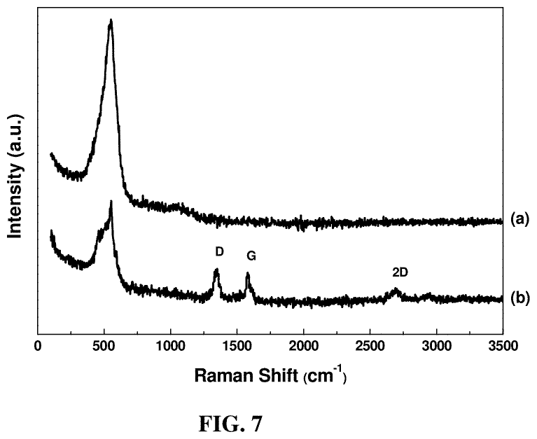

In an experiment, 50 to 200 grams of graphene embraced plastic milling media as prepared in Example 15 and 5 to 20 grams of LiNi_{0.8}Co_{0.1}Mn_{0.1}O₂ particles (D50=10.7 μm) were placed in a ball milling machine and processed at 100 rpm for 20 minutes. After that, graphene-embraced plastic milling media and graphene-embraced LiNi_{0.8}Co_{0.1}Mn_{0.1}O₂ particles were separated by sieving. The as-prepared graphene embraced LiNi_{0.8}Co_{0.1}Mn_{0.1}O₂ particles were examined by Raman spectroscopy and the results (FIG. 7) also indicated that single to few layers of graphene was on surface of it. Typical value of graphene content in graphene embraced LiNi_{0.8}Co_{0.1}Mn_{0.1}O₂ in this example was <0.5 wt %.

### Example 17: Preparation and Electrochemical Testing of Various Battery Cells

For the active materials investigated, we prepared lithium-ion cells using the conventional slurry coating method. A typical cathode composition includes 97 wt. % active material (e.g., graphene-encapsulated LiNi_{0.6}Co_{0.2}Mn_{0.2}O₂ or LiNi_{0.8}Co_{0.1}Mn_{0.1}O₂ particles or those as received), 1 wt. % carbon black (Super C65), and 2 wt. % polyvinylidene fluoride binder (PVDF) dissolved in N-methyl-2-pyrrolidinoe (NMP). After coating the slurries on Al foil (thickness: 15 μm), pre-drying and calendaring, the electrodes were dried at 120° C. in vacuum overnight to remove the solvent. Typical packing density of the cathode as prepared was about 3.2 g/cm³. For half-cell tests, lithium metal foil were used as anode and Celgard 2400 membrane were used as separator layer. The electrolyte used was 1 M LiPF₆ dissolved in a mixture of ethylene carbonate (EC), ethyl methyl carbonate (EMC), and dimethyl carbonate (DMC) (1:1:1 v/v) with 1% vinylene carbonate (VC) as additive. The cell assemblies were made in an argon-filled glove-box (MBraun, H₂O and O₂ contents both <0.1 ppm).

The electrochemical performances of various cells were evaluated by charge/discharge cycling at selected C-rates (0.1C-0.1C, 0.5C-0.5C, 1C-1C, 1C-2C, and 1C-5C) at room temperature. At each charge step, there was always a constant voltage charging following a constant current charging to insure full charging. Since the intrinsic crystal stability at high voltage (>4.2V) could be different, the cut-off voltages were set as 3.0 to 4.4V for LiNi_{0.6}Co_{0.2}Mn_{0.2}O₂ (with and/or without graphene) and 2.5 to 4.2V for LiNi_{0.8}Co_{0.1}Mn_{0.1}O₂ (with and/or without graphene).

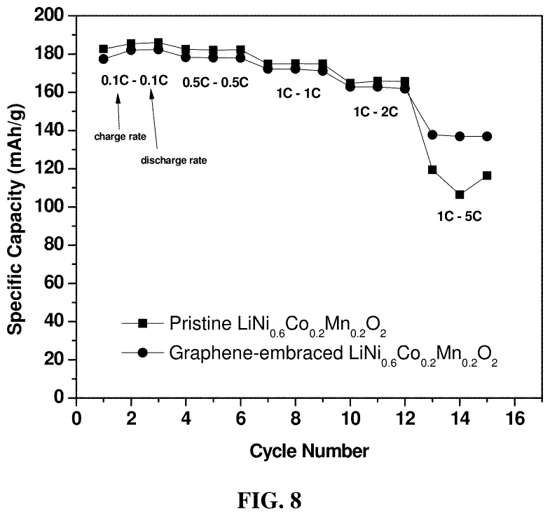

Shown in FIG. 8 are the charge-discharge behaviors of LiNi_{0.6}Co_{0.2}Mn_{0.2}O₂ as received and graphene embraced LiNi_{0.6}Co_{0.2}Mn_{0.2}O₂ at different C-rates. These data demonstrated that while no obvious difference at C-rates lower than 2C discharging, capacity of graphene-embraced LiNi_{0.6}Co_{0.2}Mn_{0.2}O₂ has shown great improvement when discharging at 5C rate.

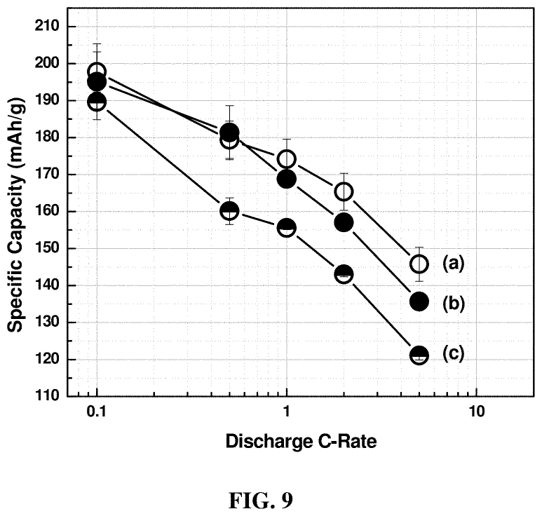

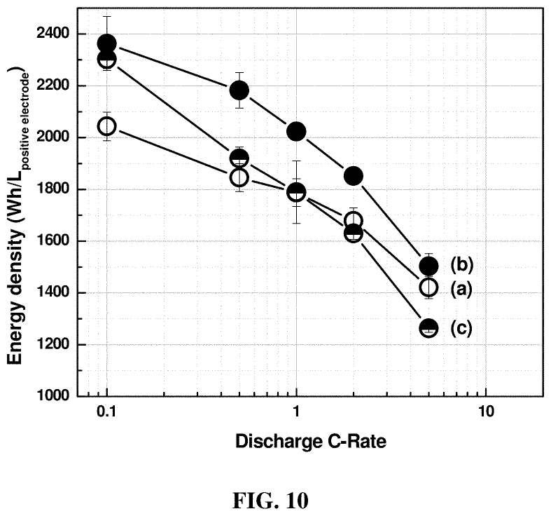

Furthermore, FIG. 9 and FIG. 10 showed the rate performances of LiNi_{0.8}Co_{0.1}Mn_{0.1}O₂ with or without graphene embraced on it. In these two figures, the results of (a) and (c) compared rate performances of electrodes with the same materials but different compositions. Specifically, the electrode shown in (a) of both figures contained 90% active material, 6% Super C65, and 4% PVDF, but the other contained 97% active material, 1% Super C65, and 2% PVDF. Varying electrode compositions is a common strategy to make Li-ion batteries for different applications. With more (but not too much) conductive carbon, the usable capacity of a Li-ion battery at high rates (>1C) will increase because of better distributed and connected electron pathways, and thus it will be suitable for mobile power tools, for example. However, due to more inactive components in the electrode, its energy density will be lower when running at low rates (0.1C for instance) compared to those with less conductive carbon. In the case of less conductive carbon being used in an electrode, the trend will be opposite. The results shown in (a) and (c) of both FIG. 9 and FIG. 10 have well demonstrated the mentioned trends, and we can call (a) Power-type cell and (c) Energy-type cell.

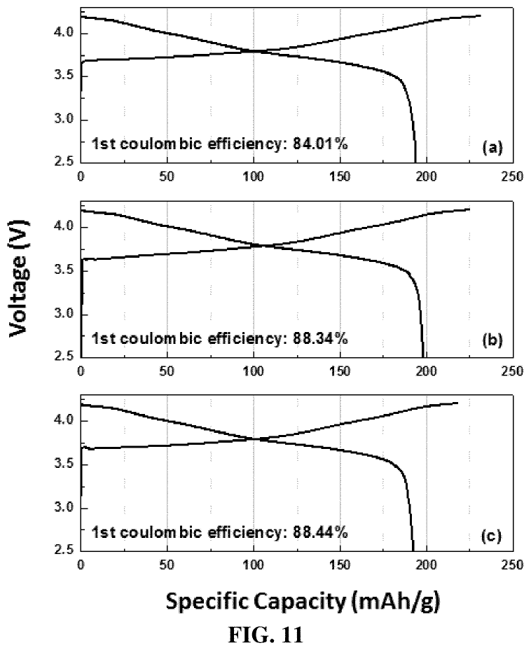

To check if graphene-embraced on LiNi_{0.8}Co_{0.1}Mn_{0.1}O₂ can improve rate performances in terms of volumetric energy density, the electrode in composition of 97% active material (including graphene), 1% Super C65, and 2% PVDF was made and the performance results were shown in (b) of both FIG. 9 and FIG. 10. It is clear that in FIG. 9 the graphene-embraced LiNi_{0.8}Co_{0.1}Mn_{0.1}O₂ outperformed the Energy-type cell at all tested C-rates and showed capacities close to Power-type cell. In addition, taking advantages of <0.5 wt % graphene and less carbon black and PVDF, graphene-embraced LiNi_{0.8}Co_{0.1}Mn_{0.1}O₂ has shown higher volumetric energy densities at positive electrode level at all selected rates over the other two samples. FIG. 11 compares the first-cycle charge-discharge curves of (a) Power-type cell, (b) graphene embraced LiNi_{0.8}Co_{0.1}Mn_{0.1}O₂, and (c) Energy-type cell. It may be noted that the 1^{st} cycle coulombic efficiencies of three samples were comparable to one another, meaning the incorporation of graphene on LiNi_{0.8}Co_{0.1}Mn_{0.1}O₂ would not cause any additional undesirable reaction with electrolyte that might result in loss of active lithium ions.

In summary, FIG. 4-FIG. 11 are examples that demonstrate the surprisingly superior graphene embracing effects and electrochemical performances of lithium batteries featuring the presently invented graphene-encapsulated Ni-rich NCM active material particles. It is well known that Ni-rich NCM is one of those active materials that are highly sensitive to environments during synthesis or other treatments. Hence, these results are the best examples to prove the great effectiveness of current invention, which can also be applied to other active materials used in other types of batteries, such as other lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, zinc-air battery, lithium-ion capacitors, and sodium-ion capacitors.

1. A media-transfer method of producing a graphene-embraced or graphene-encapsulated electrode active material directly from a graphitic material, said method comprising:
a) mixing multiple particles of a graphitic material and milling media in a first impacting chamber of a first energy impacting apparatus;
b) operating said first energy impacting apparatus with a frequency and an intensity for a length of time sufficient for peeling off graphene sheets from said particles of graphitic material and transferring said peeled graphene sheets to surfaces of said milling media to produce graphene-embraced milling media inside said first impacting chamber;
c) mixing said graphene-embraced milling media and multiple particles of a solid electrode active material in a second impacting chamber of a second energy impacting apparatus, wherein said second impacting chamber is the same or different than said first impacting chamber and said second energy impacting apparatus is the same or different than the first energy impacting apparatus; and
d) operating said second energy impacting apparatus with a frequency and an intensity for a length of time sufficient for peeling off graphene sheets from said graphene-embraced milling media and transferring said peeled graphene sheets to surfaces of said multiple particles of a solid electrode active material to produce graphene-embraced or graphene-encapsulated particles of electrode active material inside said second impacting chamber; and
e) recovering said graphene-embraced or graphene-encapsulated particles of electrode active material from said second impacting chamber.

2. The method of claim 1, wherein said graphitic material has never been previously intercalated, oxidized, or exfoliated and said impacting chamber contains therein no previously produced isolated graphene sheets.

3. The method of claim 1, wherein said milling media contain a material selected from the group consisting of polyamides, polycarbonate, polyester, polyethylene, high-density polyethylene, low-density polyethylene, polyethylene terephthalate, polypropylene, polystyrene, high impact polystyrene, polyurethanes, polyvinylchloride, polyvinylidene chloride, acrylonitrile butadiene styrene, polyepoxide, polymethyl methacrylate, polytetrafluoroethylene, phenolics (or phenol formaldehyde, melamine formaldehyde, urea-formaldehyde, polyetheretherketone, maleimide/bismaleimide, polyethrimide, polyimide, plastarch materials, polylactic acid, furan, silicone, polysulfone, natural rubber, bromo isobutylene isoprene rubber, polybutadiene, chloro isobutylene isoprene rubber, polychloroprene rubber, chlorosulphonated polyethylene, epichlorohydrin, ethylene propylene, ethylene propylene diene monomer (EPDM), fluorinated hydrocarbon rubber, fluoro silicone rubber, hydrogenated nitrile butadiene, polyisoprene rubber, isobutylene isoprene butyl rubber, methyl vinyl silicone rubber, acrylonitrile butadiene rubber, styrene butadiene rubber, styrene ethylene/butylene styrene rubber, polysiloxane rubber, polysiloxane rubber, and combinations thereof.

4. The method of claim 1, wherein said milling media is in a regular or irregular shape and in a size of less than 10 cubic centimeters.

5. The method of claim 1, further comprising a step of incorporating said graphene-embraced electrode active material into a battery electrode.

6. The method of claim 1, wherein an amount of residual graphitic material, if any, remains after said step d) and said method further comprises a step of incorporating said graphene-embraced or graphene-encapsulated particles of electrode active material and said residual graphitic material, if any, into a battery electrode wherein said residual graphitic material, if any, is used as a conductive additive in said battery electrode.

7. The method of claim 1, wherein said particles of solid electrode active material contain prelithiated or pre-sodiated particles having 0.1% to 54.7% by weight of lithium or sodium ions preloaded into said particles prior to step (a) of mixing.

8. The method of claim 1, wherein said particles of solid electrode active material contain particles pre-coated with a layer of conductive material selected from a carbon, pitch, carbonized resin, conductive polymer, conductive organic material, metal coating, metal oxide shell, or a combination thereof.

9. The method of claim 1, wherein said particles of solid electrode active material contain particles pre-coated with a carbon precursor material prior to step (a), wherein said carbon precursor material is selected from a coal tar pitch, petroleum pitch, mesophase pitch, polymer, organic material, or a combination thereof so that said carbon precursor material resides between surfaces of said particles of solid electrode active material and said graphene sheets, and said method further contains a step of heat-treating said graphene-embraced electrode active material to convert said carbon precursor material to a carbon material and pores, wherein said pores form empty spaces between surfaces of said particles of solid electrode active material and said graphene sheets and said carbon material is coated on said surfaces of solid electrode active material particles and/or chemically bonds said graphene sheets together.

10. The method of claim 1, wherein said particles of solid electrode active material contain particles pre-coated with a sacrificial material selected from a metal, pitch, polymer, organic material, or a combination thereof so that said sacrificial material resides between surfaces of said particles of solid electrode active material and said graphene sheets, and said method further contains a step of partially or completely removing said sacrificial material to form empty spaces between surfaces of said solid electrode active material particles and said graphene sheets.

11. The method of claim 1, further comprising a step of exposing said graphene-embraced electrode active material to a liquid or vapor of a conductive material that is conductive to electrons and/or ions of lithium, sodium, magnesium, aluminum, or zinc.

12. The method of claim 1, wherein said particles of electrode active material are an anode active material selected from the group consisting of:
(A) lithiated and un-lithiated silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd);
(B) lithiated and un-lithiated alloys or intermetallic compounds of Si, Ge, Sn, Pb, Sb, Bi, Zn, Al, Ti, Ni, Co, or Cd with other elements;
(C) lithiated and un-lithiated oxides, carbides, nitrides, sulfides, phosphides, selenides, and tellurides of Si, Ge, Sn, Pb, Sb, Bi, Zn, Al, Ti, Fe, Ni, Co, or Cd, and their mixtures, composites, or lithium-containing composites;
(D) lithiated and un-lithiated salts and hydroxides of Sn;
(E) lithium titanate, lithium manganate, lithium aluminate, lithium-containing titanium oxide, lithium transition metal oxide;
and combinations thereof.

13. The method of claim 1, wherein said electrode active material is a cathode active material selected from an inorganic material, an organic or polymeric material, a metal oxide/phosphate/sulfide, or a combination thereof.

14. The method of claim 13, wherein said metal oxide/phosphate/sulfide is selected from a lithium cobalt oxide, lithium nickel oxide, lithium manganese oxide, lithium vanadium oxide, lithium-mixed metal oxide, lithium iron phosphate, lithium manganese phosphate, lithium vanadium phosphate, lithium mixed metal phosphate, sodium cobalt oxide sodium nickel oxide, sodium manganese oxide, sodium vanadium oxide, sodium-mixed metal oxide, sodium iron phosphate, sodium manganese phosphate, sodium vanadium phosphate, sodium mixed metal phosphate, transition metal sulfide, lithium polysulfide, sodium polysulfide, magnesium polysulfide, or a combination thereof.

15. The method of claim 1, wherein said electrode active material is a cathode active material selected from sulfur, sulfur compound, sulfur-carbon composite, sulfur-polymer composite, lithium polysulfide, transition metal dichalcogenide, a transition metal trichalcogenide, or a combination thereof.

16. The method of claim 13, wherein said inorganic material is selected from TiS₂, TaS₂, MoS₂, NbSe₃, MnO₂, CoO₂, an iron oxide, a vanadium oxide, or a combination thereof.

17. The method of claim 13, wherein said metal oxide/phosphate/sulfide contains a vanadium oxide selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5.

18. The method of claim 13, wherein said metal oxide/phosphate/sulfide is selected from a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

19. The method of claim 13, wherein said inorganic material is selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof.

20. The method of claim 13, wherein said organic material or polymeric material is selected from poly(anthraquinonyl sulfide) (PAQS), a lithium oxocarbon, 3,4,9,10-perylenetetracarboxylic dianhydride (PTCDA), poly(anthraquinonyl sulfide), pyrene-4,5,9,10-tetraone (PYT), polymer-bound PYT, quino(triazene), redox-active organic material, tetracyanoquinodimethane (TCNQ), tetracyanoethylene (TCNE), 2,3,6,7,10,11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, hexaazatrinaphtylene (HATN), hexaazatriphenylene hexacarbonitrile (HAT(CN)₆), 5-Benzylidene hydantoin, isatine lithium salt, pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

21. The method of claim 20, wherein said thioether polymer is selected from poly[methanetetryl-tetra(thiomethylene)] (PMTTM), poly(2,4-dithiopentanylene) (PDTP), a polymer containing poly(ethene-1,1,2,2-tetrathiol) (PETT) as a main-chain thioether polymers, a side-chain thioether polymer having a main-chain consisting of conjugating aromatic moieties, and having a thioether side chain as a pendant, poly(2-phenyl-1,3-dithiolane) (PPDT), poly(1,4-di(1,3-dithiolan-2-yl)benzene) (PDDTB), poly(tetrahydrobenzodithiophene) (PTHBDT), poly[1,2,4,5-tetrakis(propylthio)benzene](PTKPTB, or poly[3,4(ethylenedithio)thiophene] (PEDTT).

22. The method of claim 13, wherein said organic material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof.

23. The method of claim 1, wherein said electrode active material is a cathode active material containing a mixture of an organic material and an inorganic material or a metal oxide/phosphate/sulfide.

24. The method of claim 1, wherein said electrode active material particles include powder, flakes, beads, pellets, spheres, wires, fibers, filaments, discs, ribbons, or rods, having a diameter or thickness from 10 nm to 20 μm.

25. The method of claim 24, wherein said diameter or thickness is from 1 nm to 10 nm.

26. The method of claim 1, wherein said graphitic material is selected from natural graphite, synthetic graphite, highly oriented pyrolytic graphite, graphite fiber, graphitic nanofiber, graphite fluoride, chemically modified graphite, mesocarbon micro-bead, partially crystalline graphite, or a combination thereof.

27. The method of claim 1, wherein the energy impacting apparatus is selected from a double cone mixer (or mill), double cone blender, vibratory ball mill, planetary ball mill, high energy mill, basket mill, agitator ball mill, cryogenic ball mill, microball mill, tumbler ball mill, attritor, continuous ball mill, stirred ball mill, pressurized ball mill, plasma-assisted ball mill, freezer mill, vibratory sieve, bead mill, nanobead mill, ultrasonic homogenizer mill, centrifugal planetary mixer, vacuum ball mill, or resonant acoustic mixer.

28. The method of claim 1 wherein said graphene sheets contain single-layer graphene sheets.

29. The method of claim 1, wherein said procedure of operating said energy impacting apparatus is conducted in a continuous manner using a continuous energy impacting device.

30. A mass of graphene-embraced particles of solid active material produced by the method of claim 1, wherein a graphene proportion is from 0.0001% to 20% by weight based on the total weight of graphene and solid active material particles combined.

31. A mass of graphene-embraced particles of solid active material, wherein a graphene proportion is from 0.0001% to 0.1% by weight based on the total weight of graphene and solid active material particles combined.

32. A battery electrode containing said graphene-embraced or graphene-encapsulated particles of electrode active material produced in claim 1.

33. A battery containing the battery electrode of claim 32.

34. A battery electrode containing said graphene-embraced or graphene-encapsulated electrode active material produced in claim 1 as an electrode active material, wherein said battery is a lithium-ion battery, lithium metal secondary battery, lithium-sulfur battery, lithium-air battery, lithium-selenium battery, sodium-ion battery, sodium metal secondary battery, sodium-sulfur battery, sodium-air battery, magnesium-ion battery, magnesium metal battery, aluminum-ion battery, aluminum metal secondary battery, zinc-ion battery, zinc metal battery, or zinc-air battery.
